(19) United States
(12) Patent Application Publication
(10) Pub. No.: US 2025/0109949 A1
(43) Pub. Date: Apr. 3, 2025

(54) SYSTEMS AND METHODS FOR PRESENTING DIRECTIONAL INFORMATION BASED ON CONTEXTUAL DATA

(71) Applicant: Apple Inc., Cupertino, CA (US)

(72) Inventor: Hollie R. FIGUEROA, Cupertino, CA (US)

(21) Appl. No.: 18/898,544

(22) Filed: Sep. 26, 2024

Related U.S. Application Data
(60) Provisional application No. 63/586,335, filed on Sep. 28, 2023.

(51) Int. Cl. G01C 21/34; G01C 21/36

(52) U.S. Cl. CPC G01C 21/3415; G01C 21/3629

(57) ABSTRACT

In some embodiments, an electronic device in communication with a display generation component and one or more input devices presents directional information corresponding to a determined route and selectively redirects the user back to the determined route in response to detecting that the user of the electronic device is no longer following the determined route based on contextual data.

### CROSS-REFERENCE TO RELATED APPLICATIONS

This application claims the benefit of U.S. Provisional Application No. 63/586,335, filed Sep. 28, 2023, the content of which is herein incorporated by reference in its entirety for all purposes.

### FIELD OF THE DISCLOSURE

This disclosure relates generally to an electronic device presenting directional information to a user of the electronic device based on contextual data.

### BACKGROUND OF THE DISCLOSURE

User interaction with electronic devices has increased significantly in recent years. These devices can be devices such as computers, tablet computers, televisions, multimedia devices, or mobile devices. While using a navigation application to traverse along a route, the user of the electronic device may wish to be presented with directional information to help the user reach a desired destination. The user may therefore desire efficient ways in which the electronic device presents the directional information to the user while navigating along a route.

### SUMMARY OF THE DISCLOSURE

Providing efficient ways of presenting directional information to a user via an application of an electronic device based on contextual data while navigating along a route may improve the user's experience with the electronic device and reduce the number of inputs needed to exit or pause the application that is providing navigation directions, thereby reducing power usage and improving the battery life of the electronic device.

In some embodiments, an electronic device presents directional information corresponding to a determined route and selectively redirects the user back to the determined route in response to detecting that the user of the electronic device is no longer following the determined route based on contextual data. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6E illustrate examples of an electronic device presenting directional information corresponding to navigation directions from a first location to a second location along a determined route and selectively redirecting a user back to the determined route using contextual data when detecting that the electronic device is no longer following the determined route according to some embodiments of the disclosure.

FIG. 7 is a flow diagram illustrating a method in which an electronic device presents directional information corresponding to navigation directions from a first location to a second location along a determined route and selectively redirects a user back to the determined route using contextual data when detecting that the electronic device is no longer following the determined route according to some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

There is a need for an electronic device to efficiently present directional information to a user of the electronic device to help the user reach a desired destination. In some embodiments, an electronic device presents directional information corresponding to a determined route and selectively redirects the user back to the determined route based on contextual data. Further, by selectively redirecting a user back to a determined route based on contextual data, the user experience is enhanced and the user interaction with the electronic device is simplified. Presentation of directional informational using the techniques described reduces the number of inputs needed to exit or pause the application running on the electronic device that is providing the navigation directions and thereby reducing power usage and improving the battery life of the electronic device.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

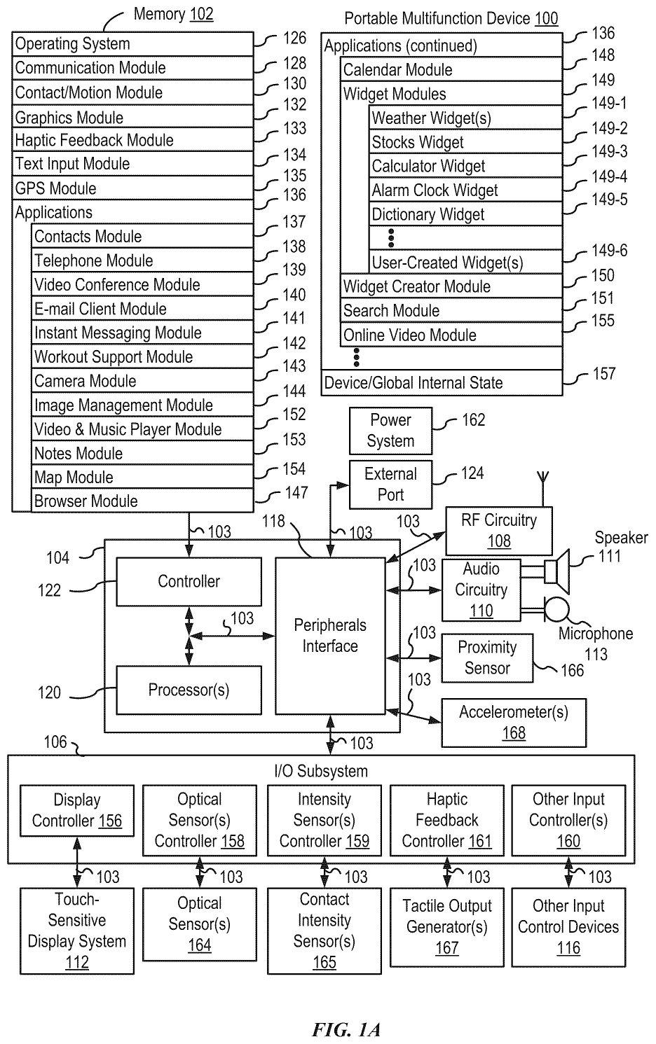

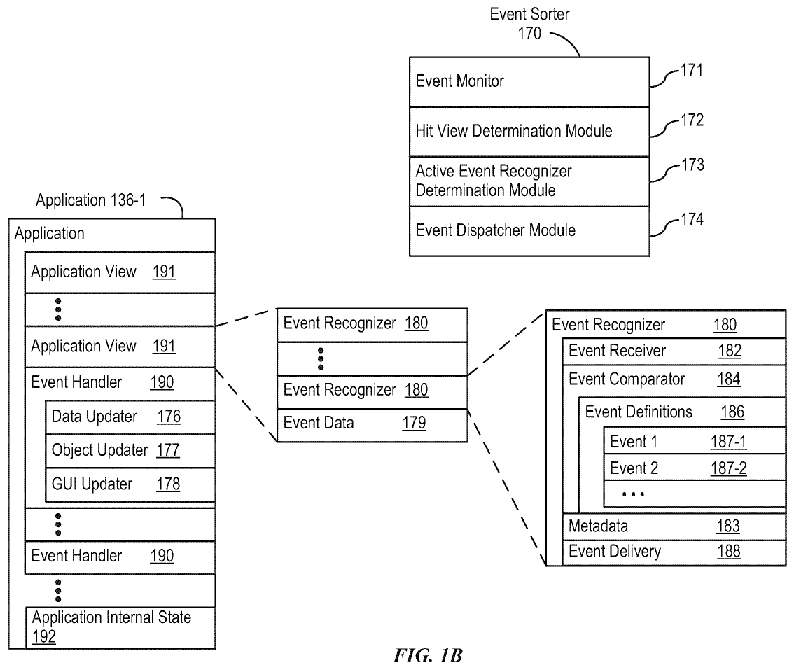

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

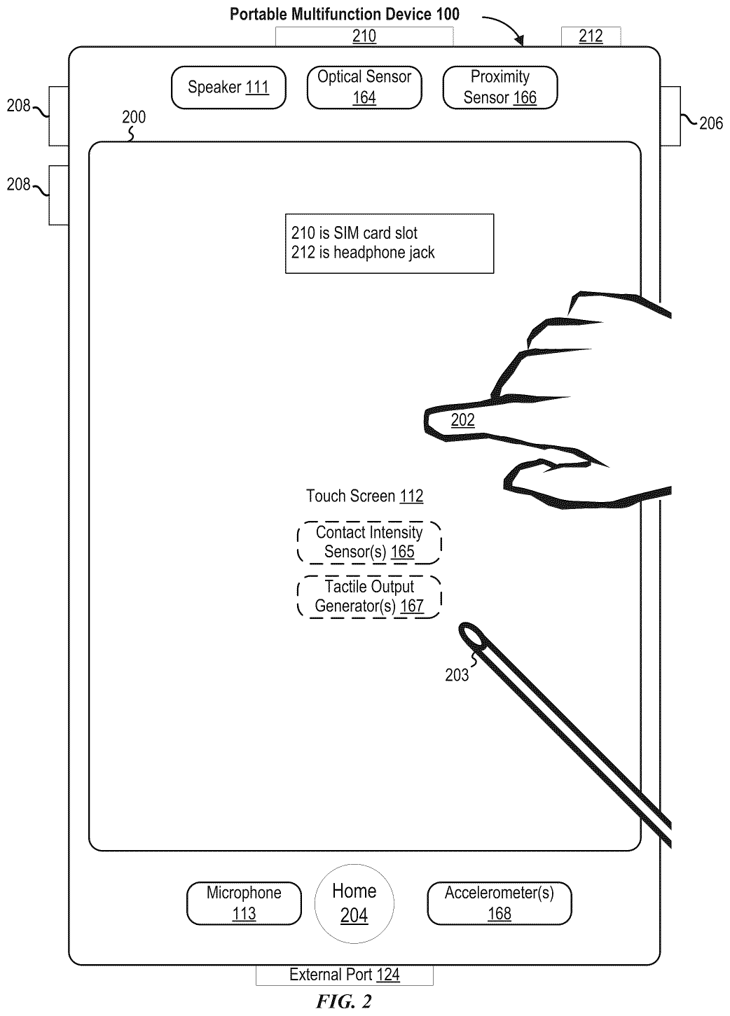

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

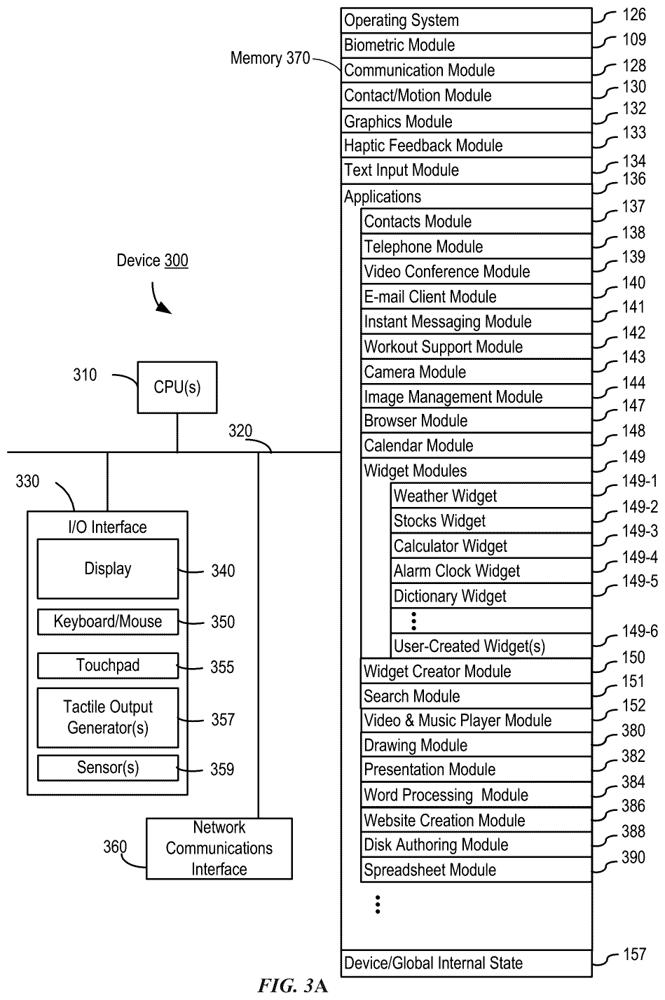

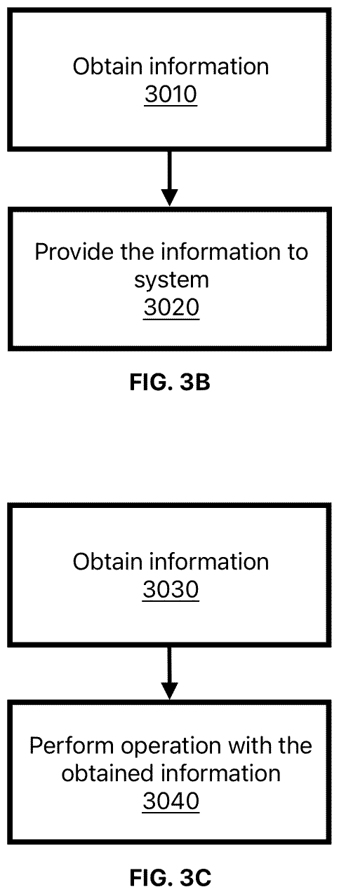

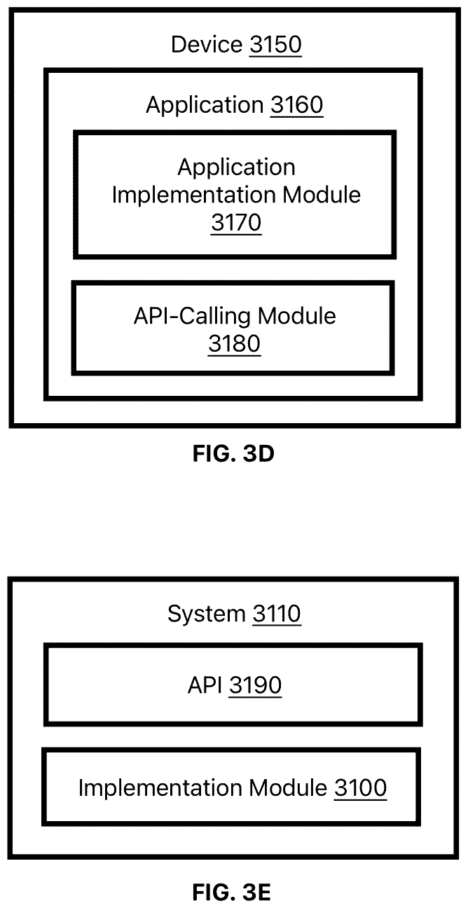

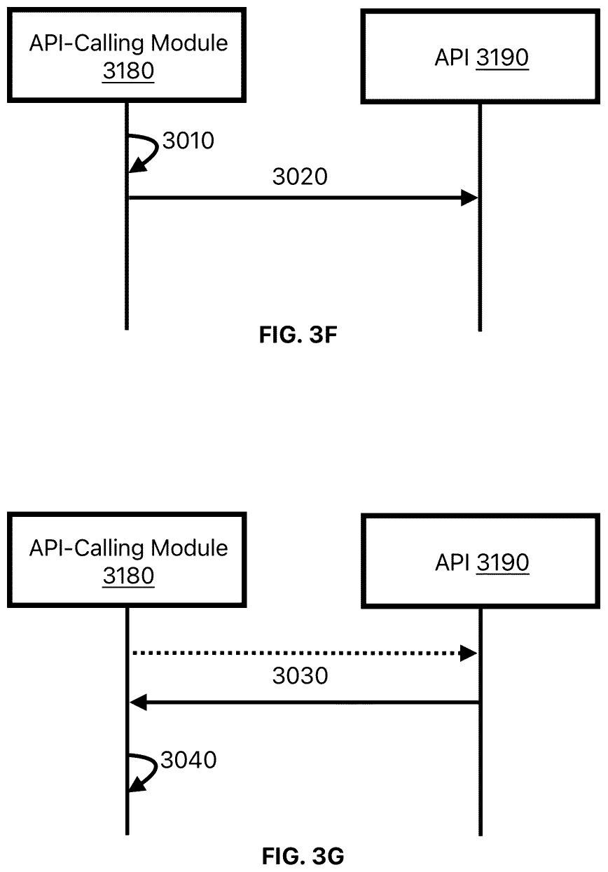

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

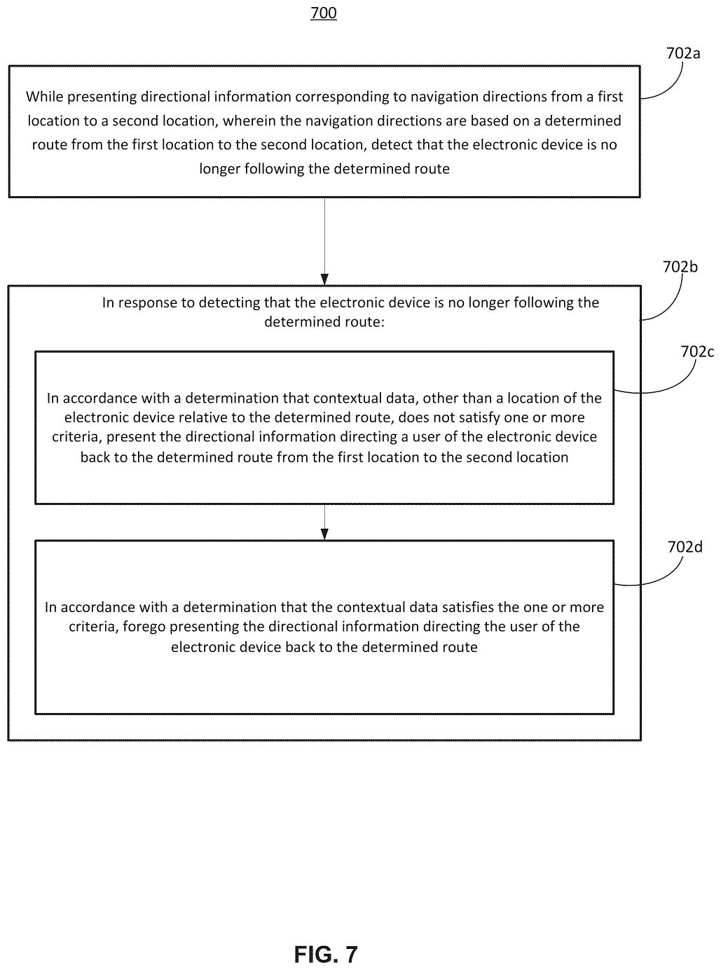

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

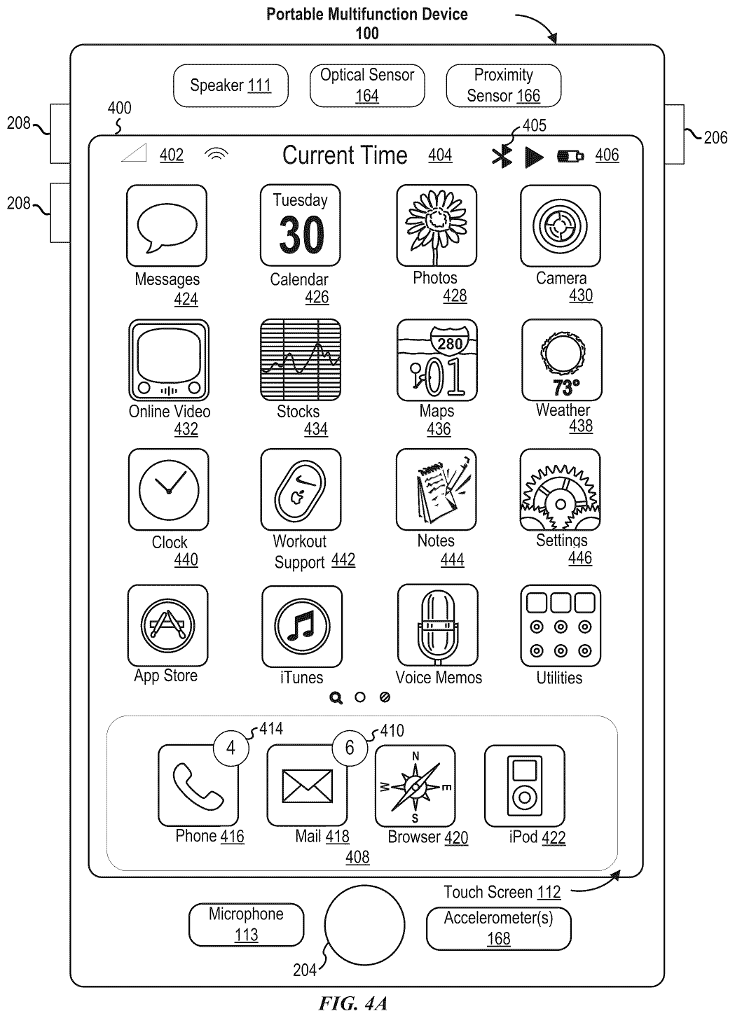

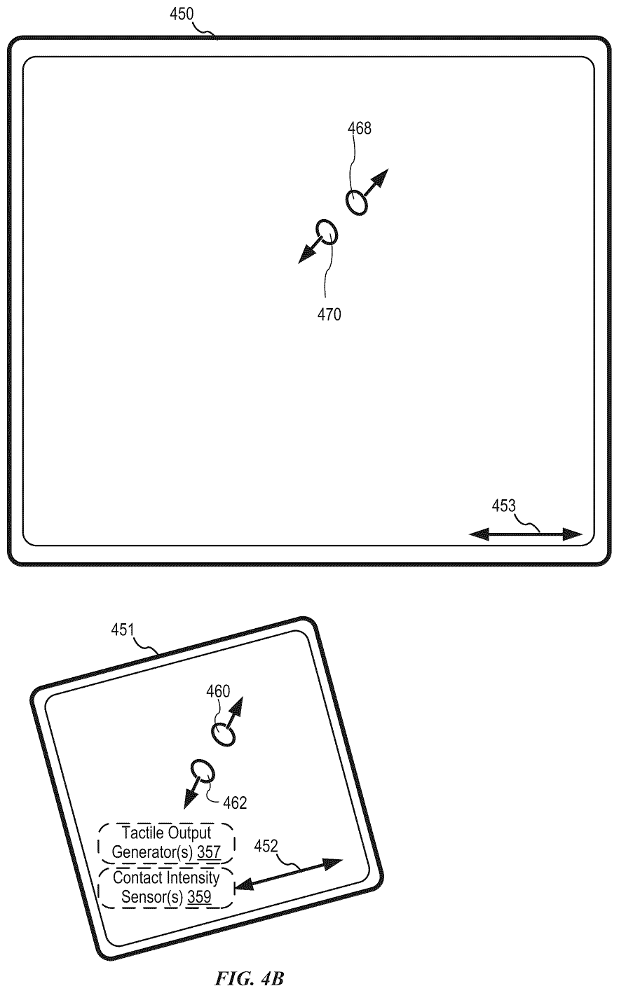

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:

Signal strength indicator(s) 402 for wireless communication(s), such as cellular and Wi-Fi signals;

Time 404;

Bluetooth indicator 405;

Battery status indicator 406;

Tray 408 with icons for frequently used applications, such as:

Icon 416 for telephone module 138, labeled “Phone,” which optionally includes an indicator 414 of the number of missed calls or voicemail messages;

Icon 418 for e-mail client module 140, labeled “Mail,” which optionally includes an indicator 410 of the number of unread e-mails;

Icon 420 for browser module 147, labeled “Browser;” and

Icon 422 for video and music player module 152, also referred to as iPod (trademark of Apple Inc.) module 152, labeled “iPod;” and

Icons for other applications, such as:

Icon 424 for IM module 141, labeled “Messages;”

Icon 426 for calendar module 148, labeled “Calendar;”

Icon 428 for image management module 144, labeled “Photos;”

Icon 430 for camera module 143, labeled “Camera;”

Icon 432 for online video module 155, labeled “Online Video;”

Icon 434 for stocks widget 149-2, labeled “Stocks;”

Icon 436 for map module 154, labeled “Maps;”

Icon 438 for weather widget 149-1, labeled “Weather;”

Icon 440 for alarm clock widget 149-4, labeled “Clock;”

Icon 442 for workout support module 142, labeled “Workout Support;”

Icon 444 for notes module 153, labeled “Notes;” and

Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

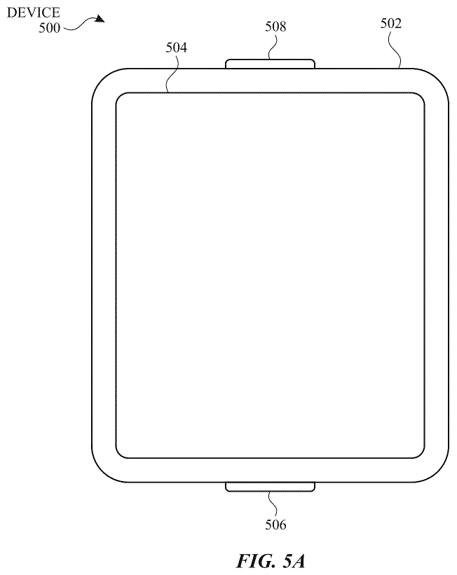

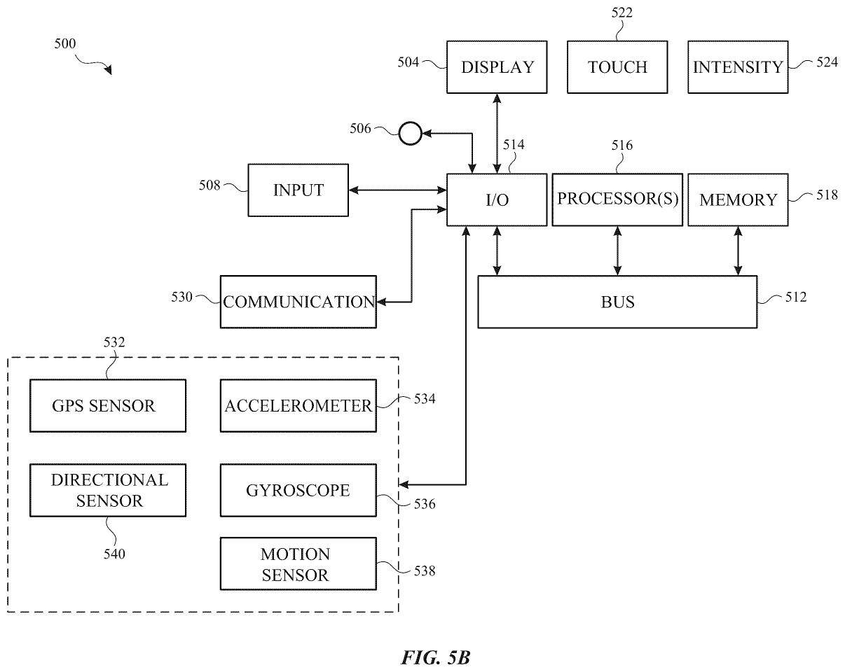

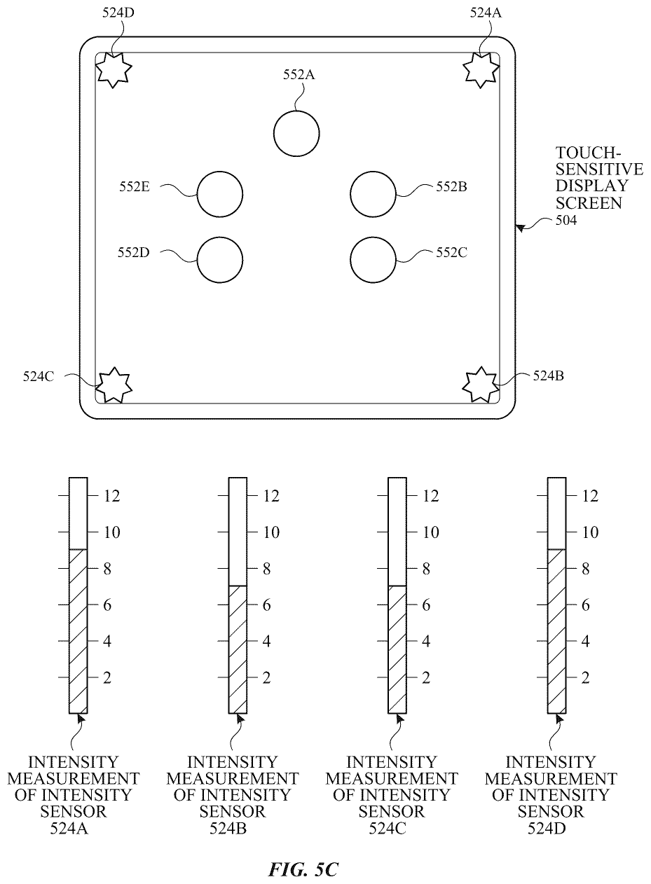

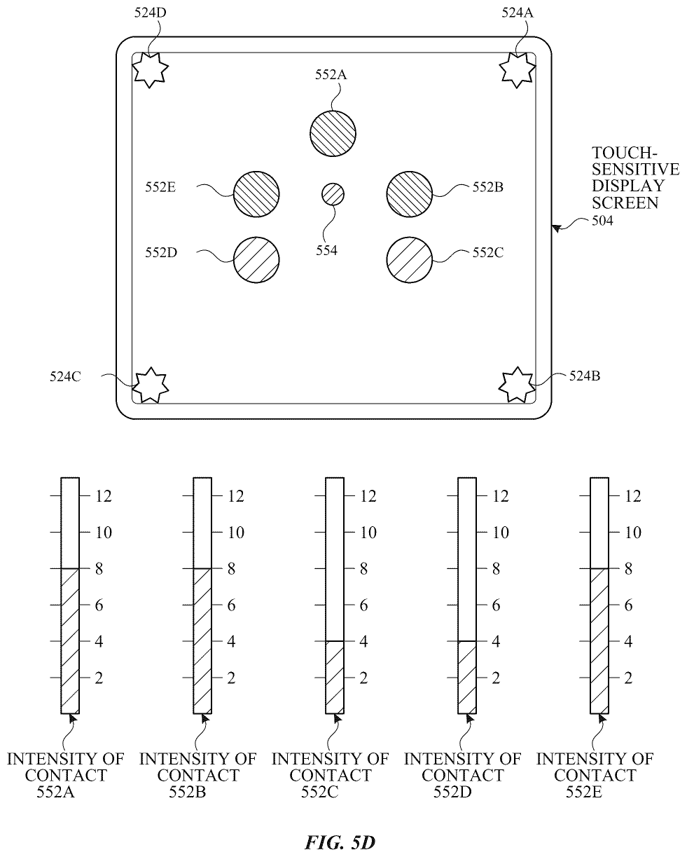

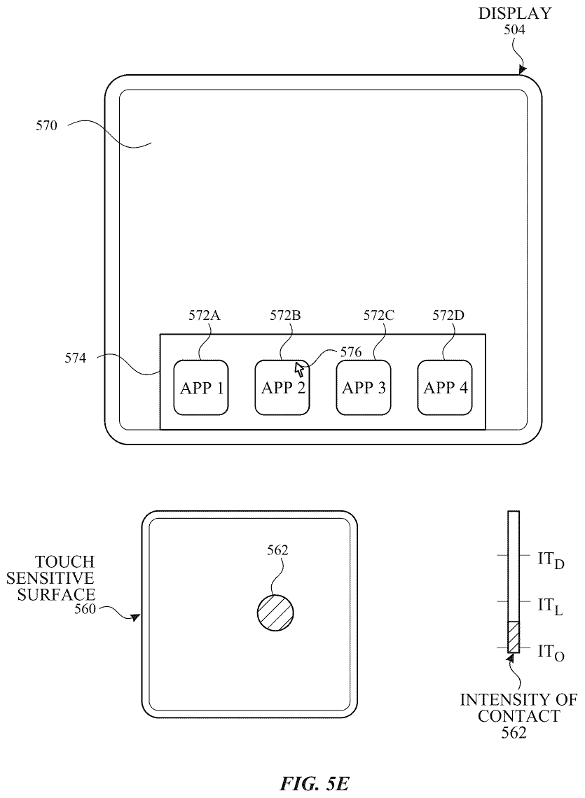

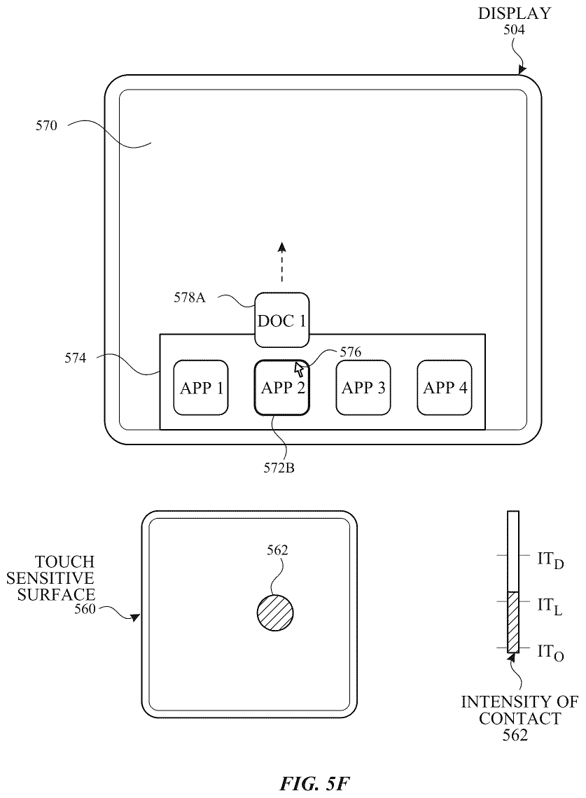

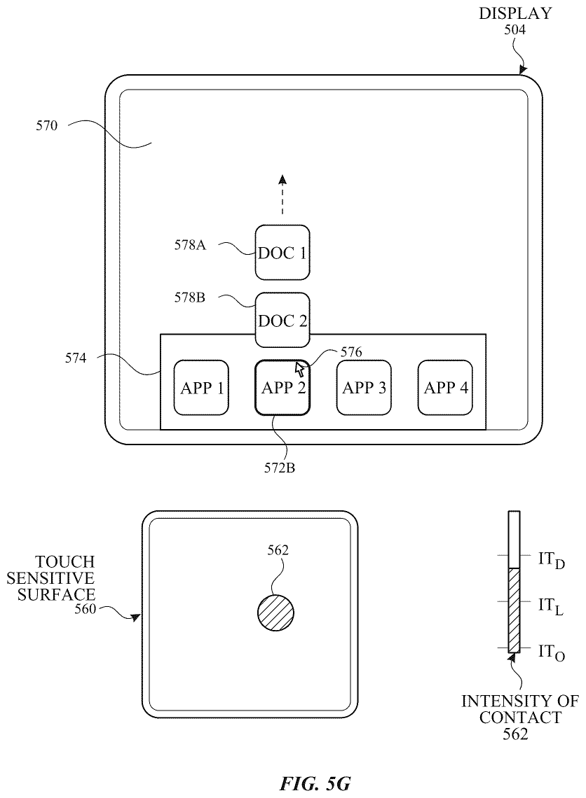

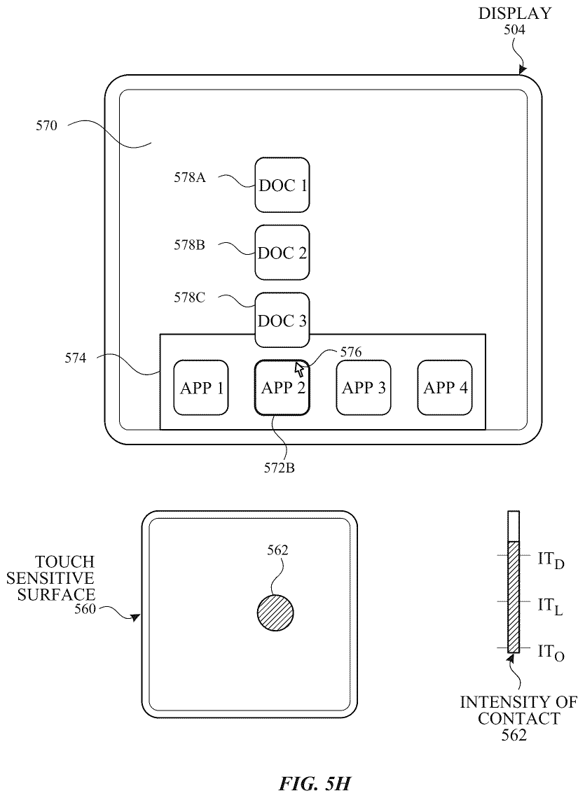

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces and Associated Processes

### Presenting Directional Information Corresponding to a Determined Route and Selectively Redirecting a User Based on Contextual Data

Users may wish to be presented with directional information when navigating along a determined route to reach a desired destination. In some embodiments, an electronic device presents directional information corresponding to navigation directions from a first location to a second location and selectively redirects the user back to the determined route in response to detecting that the user of the electronic device is no longer following the determined route based on contextual data. Selectively redirecting a user back to a determined route based on contextual data enhances the user experience by simplifying the user interaction with the electronic device, thus reducing the number of inputs needed to exit or pause the application that is providing the navigation directions, thereby reducing power usage and improving the battery life of the electronic device.

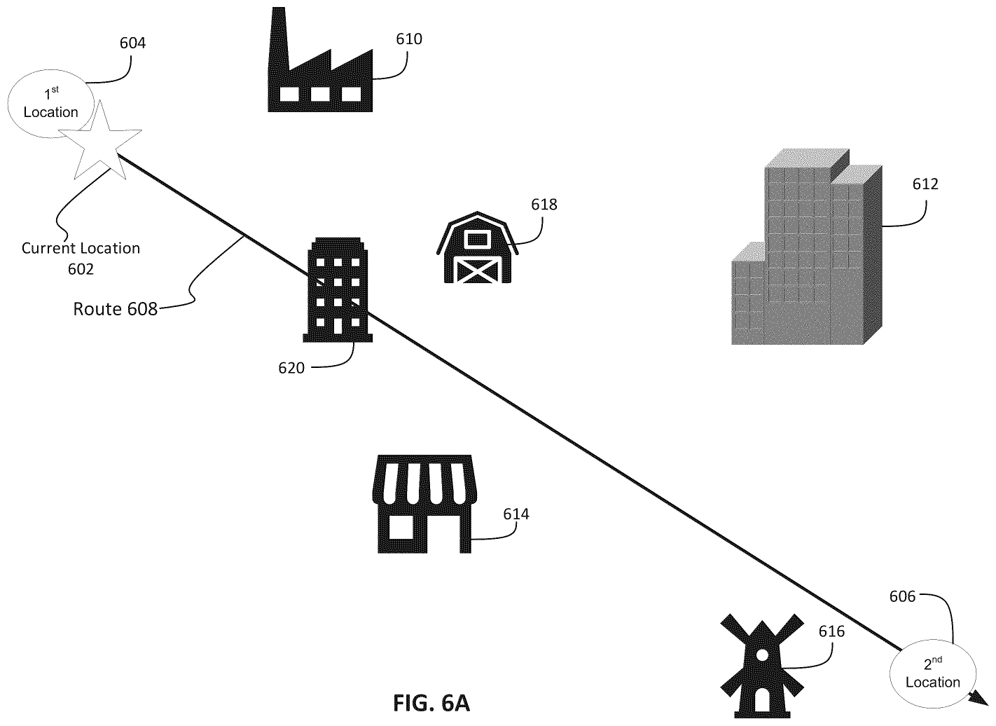

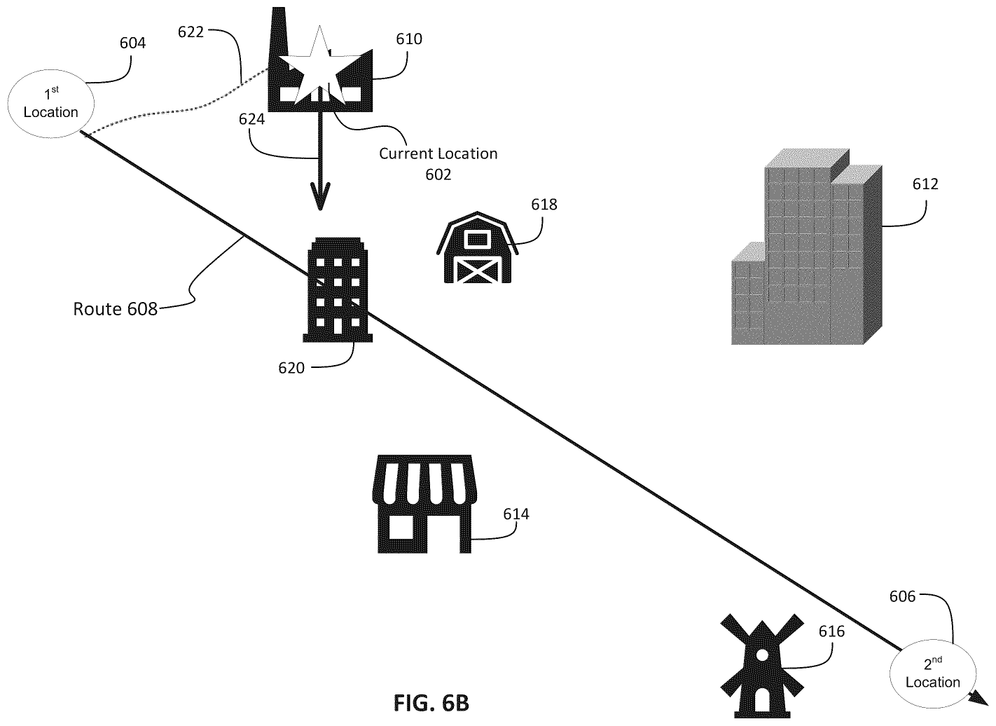

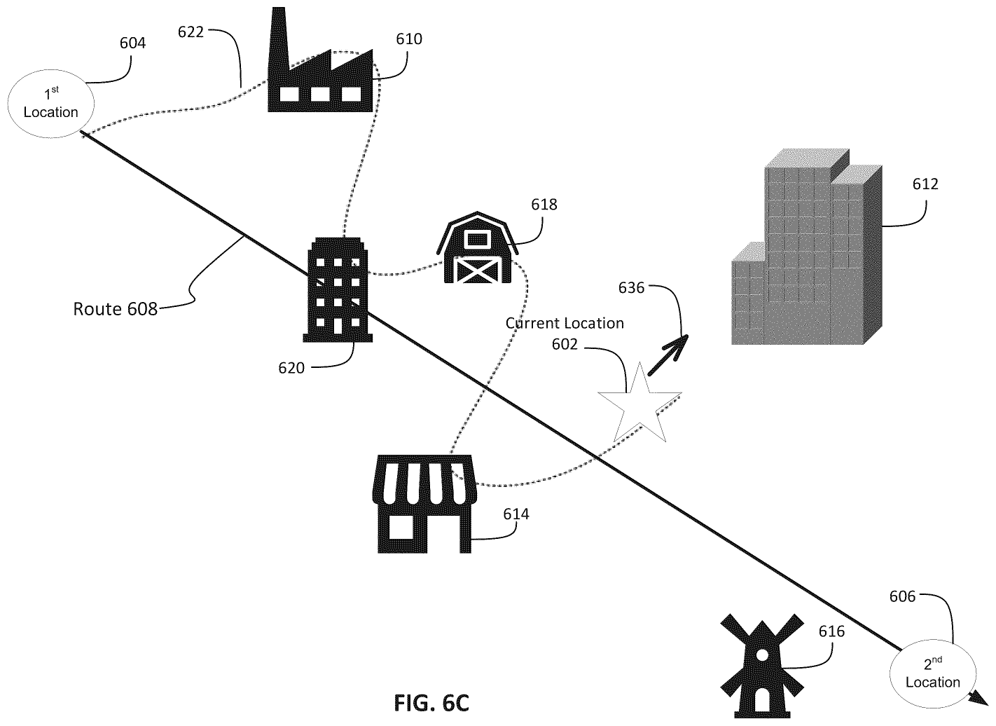

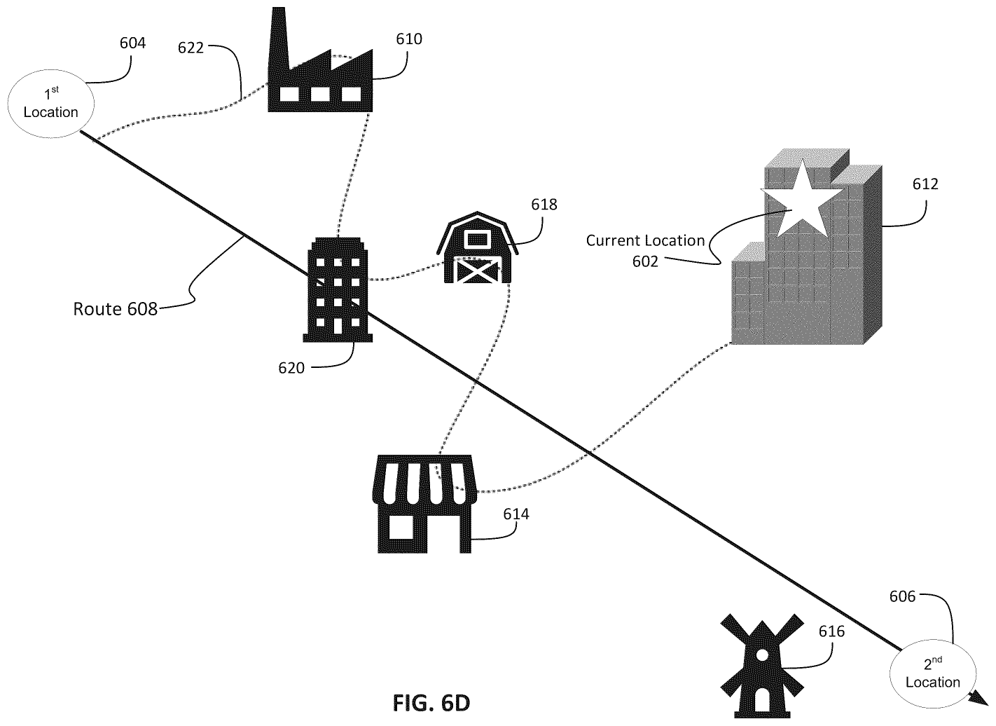

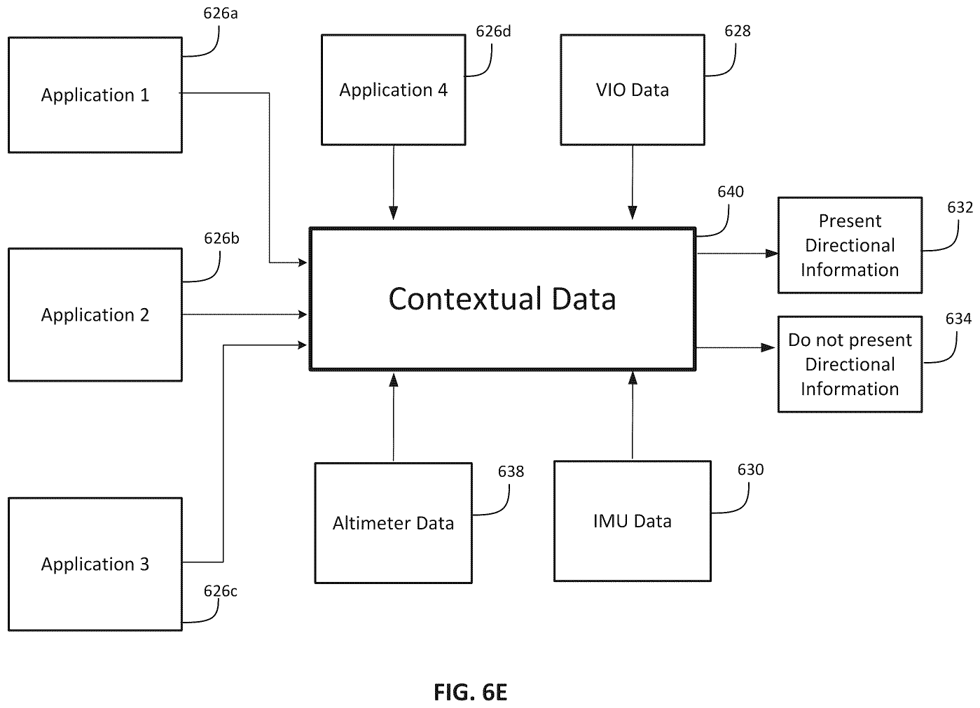

FIGS. 6A-6E illustrate exemplary ways in which an electronic device presents directional information corresponding to a determined route and selectively redirects the user back to the determined route in response to detecting that the user of the electronic device is no longer following the determined route based on contextual data. The embodiments in these figures are used to illustrate the processes described below, including the processes described with reference to FIG. 7. Although FIGS. 6A-6E illustrate various examples of ways an electronic device is able to perform the processes described below with reference to FIG. 7, it should be understood that these examples are not meant to be limiting, and the electronic device is able to perform one or more processes described below with reference to FIG. 7 in ways not expressly described with reference to FIGS. 6A-6E.

FIG. 6A illustrates an exemplary schematic of a determined route directing a user from a first location to a second location which optionally includes one or more representations of physical buildings that are along the determined route and/or not along the determined route (e.g., buildings 610-620). In the example illustrated in FIG. 6A, a display (e.g., display 514) of an electronic device optionally displays a navigation application user interface running on the electronic device 500a of which display 514 is a part, or to which display 514 is connected. While a user of the electronic device optionally uses the navigation application to traverse along a determined route 608 from a first location 604 to a second location 606, the electronic device has access to data via sensors and various applications installed on the electronic device, which provide the electronic device with access to the contextual data that includes information associated with the context of the environment corresponding to the determined route and/or the user. Additional details about the contextual data will be described in more detail with reference to FIG. 6E.

FIG. 6A illustrates exemplary navigation directions corresponding to a determined route 608 from the first location 604 to the second location 606 and the surrounding environment corresponding to the determined route 608 determined by an electronic device as the user of the electronic devices navigates from the first location 604 to the second location 606. As illustrated, a current location 602 of the user of the electronic device relative to the environment illustrated in FIG. 6A is illustrated and the surrounding environment of the determined route 608 illustrates a building 620 located along (e.g., on) the determined route 608 and buildings 610-618 that are not located along (e.g., not on) the determined route 608. In some embodiments, while the electronic device presents directional information corresponding to navigation directions from the first location 604 to the second location 606 as the user navigates along the determined route 608, the electronic device continuously tracks the current location 602 of the user of the electronic device using data from a visual sensor, an inertial sensor, an odometry sensor, and/or an inertial measurement unit, as described in more detail with reference to method 700.

In some embodiments, the electronic device presents directional information which optionally includes symbols, images, and/or words providing step-by-step directions navigating a user of the electronic device from the first location 604 to the second location 606 along the determined route 608. For example, as shown in FIG. 6A, the current location 602 of the user of the electronic device is at a front lobby of an office building (e.g., first location 604) and the user of the electronic device uses a navigation application to navigate the user to a friend's house (e.g., building 620) and to continue traversing along the determined route to a restaurant (e.g., second location 606) to have dinner. While at the current location 602, the electronic device presents a sequence of symbols and/or words directing the user to building 620 and to the second location 606 along the determined route 608 (e.g., “walk 450 meters south-east along Wilshire Blvd; enter east lobby entrance at building 620 and meet friend in lobby; walk 1100 meters south-east along Wilshire Blvd to arrive at the second location; enter north entrance and use elevator to the 50^{th} floor).

In FIG. 6B, the electronic device detects the user of the electronic device walking in a direction away from the determined route 608 and navigating along path 622 toward building 610. As shown, the current location 602 of the user of the electronic device is not along the determined route 608 and instead at building 610. In some embodiments, if it is detected that the user of the electronic device is no longer following the determined route 608, contextual data is used by the electronic device to determine whether to continue presenting directional information directing the user of the electronic device back to the determined route, or to not present directional information directing the user of the electronic device back to the determined route. For example, indicated by path 622, the user of the electronic device departs from a lobby of an office building (e.g., first location 604) and begins navigating in a north-east direction as shown instead of in a south-east along the determined route 608. At the current location 602 (e.g., building 610), if the electronic device detects that the user of the electronic device is no longer following the determined route, contextual data is used by the electronic device to determine whether to present directional information directing the user of the electronic device back to the determined route 608 based on the contextual data not satisfying one or more criteria. In one example, the one or more criteria include a criterion that is satisfied when the contextual data includes information indicating that the current location 602 (e.g., building 610) is at a location that the user of the electronic device has visited previously more than three times in the last 12 months. Because the user of the electronic device has visited building 610 only two times in the last 12 months, the criterion is not satisfied and the electronic device presents the user of the electronic device with updated directional information directing (e.g., represented by arrow 624) the user of the electronic device back to the determined route 608 from the first location 604 to the second location 606.

In some embodiments, the electronic device presents updated directional information which includes symbols, images, and/or words providing step-by-step directions navigating the user of the electronic device from the current location 602 (e.g., building 610) to a location along the determined route 608. For example, as noted above, because the user of the electronic device is using the navigation application to guide the user to a friend's house (e.g., building 620) and to continue navigating to a restaurant (e.g., second location 606) for dinner, the updated directional information optionally includes directional information that directs the user from the current location 602 to the friend's house (e.g., walk 450 meters southbound to building 620).

FIG. 6C illustrates a path 622 taken by the user of the electronic device with respect to the determined route 608 and its surrounding environment. As indicated by the path 622 in FIG. 6C, the user of the electronic device navigates in a north-east direction to building 610 and is rerouted back to the determined route 608 to building 620. After the user of the electronic device meets a friend at building 620, the user and the friend of the user go shopping at building 618 and building 614 prior to returning to the determined route 608 to navigate to the second location 606 for dinner. As further shown in FIG. 6C, while at the current location 602 (e.g., 50 meters away from the determined route 608), the electronic device is no longer following the determined route. In response to detecting that the electronic device is no longer following, contextual data is used by the electronic device to whether to forego presenting directional information directing the user of the electronic device back to the determined route 608 based on the contextual data satisfying the one or more criteria.

For example, the one or more criteria include a criterion that is satisfied when the contextual data includes information indicating that a favorite ramen restaurant is nearby, a reservation is available at the restaurant, and that the user is walking in a direction away from the determined route 608 and toward that restaurant. Because the contextual data indicates that the user is walking towards building 612, which is where the user's favorite ramen restaurant is located, and because that contextual data indicates that a reservation is available at the restaurant, the contextual data satisfies the one or more criteria, and the electronic device forgoes presenting the user of the electronic device with directional information directing the user of the electronic device back to the determined route 608 from the first location 604 to the second location 606. In some embodiments, in accordance with a determination that the contextual data satisfies the one or more criteria, the electronic device presents the user of the electronic device with updated directional information directing the user of the electronic device to the updated location (e.g., building 612). In some embodiments, the electronic device presents updated directional information which includes symbols, images, and/or words providing step-by-step directions navigating the user of the electronic device from the current location 602 to the updated location (e.g., building 612).

FIG. 6D illustrates a continued path 622 taken by the user of the electronic device after FIG. 6C, where the user of the electronic device entered building 612 at a lower floor and navigated to an upper floor building 612 and arrived at a current location 602 which is the 40^{th} floor of building 612, as an example. In some embodiments, a visual sensor, an inertial sensor, an odometry sensor, an inertial measurement unit, and/or an altimeter are included in the electronic device and/or a headphone device worn by the user. The visual sensor, the inertial sensor, and the odometry sensor are optionally integrated together to form a device (e.g., device includes visual sensor, inertial sensor, and/or odometry sensor) that is included in the electronic device and/or a headphone device worn by the user. In some embodiments, while the user of the electronic device traverses along path 622, the visual sensor, the inertial sensor, the odometry sensor, and/or the inertial measurement unit is used to determine a respective location of the electronic device relative to the determined route 608 based on data from the visual sensor, the inertial sensor, the odometry sensor, and/or the inertial measurement unit.

In some embodiments, if the electronic device is detected as having undergone a vertical change in position from a first altitude position to a second altitude position, the visual sensor, the inertial sensor, the odometry sensor, and/or the inertial measurement unit are deactivated and data from the altimeter is used to determine the current location of the electronic device relative to the determined route. For example, if the user of the electronic device uses an elevator or stairs at building 612 to reach the restaurant located on the 40^{th} floor of building 612, the visual sensor, the inertial sensor, the odometry sensor, and/or the inertial measurement unit are deactivated and the data from the altimeter is used by the electronic device to determine the current location of the electronic device as the user makes their way up the 40^{th} floor. In some embodiments, in response to determining that the electronic device is no longer undergoing a vertical change in position (e.g., electronic device reaches the 40^{th} floor), the altimeter is deactivated and the visual sensor, the inertial sensor, the odometry sensor, and/or the inertial measurement unit are reactivated and used by the electronic device to determine the current location of the electronic device as the user traverses and/or navigates along the 40^{th} floor of building 612.

FIG. 6E illustrates an example block diagram illustrating contextual data 640 utilized by the electronic device, as described above and with reference to method 700, and that includes respective input data from a plurality of applications and/or sensors, where the contextual data is optionally used to by the electronic device to selectively present directional information 632 or to cease presenting or not present directional information 634 to the user of the electronic device. As shown, the contextual data includes information from a plurality of applications 626a-626d that are optionally installed on the electronic device. The plurality of applications 626a-626d optionally includes applications such as a weather application, a personal safety network application, a restaurant and business review application, a timeline application that tracks the geolocation of a user, a clock application, a social network application, a traffic and road condition application, and/or an online restaurant-reservation application. In some embodiments, the contextual data includes information related to the behaviors, tendencies, habits, and/or the sentiment of the user of the electronic device. In some embodiments, the contextual data includes VIO data 628, which includes data from the visual sensor, the inertial sensor, and/or the odometry sensor, such as described in more detail with reference to method 700. In some embodiments, the contextual data further includes inertial measurement unit (IMU) data 630 and altimeter data 638, such as described in more detail with reference to method 700.

In some embodiments, in response to detecting that the electronic device is no longer following the determined route, selectively presenting directional information 632 or not presenting directional information 634 is based on determining whether the contextual data 640 does not satisfy one or more criteria or whether the contextual data 640 satisfies the one or more criteria. For example, while the user of the electronic device uses a navigation application to commute home, the contextual data includes data from a weather application (e.g., applications 626a) which indicates that it will be raining heavily for the next 15 minutes and that a bookstore that the user frequents regularly is at a location that is not along the determined route. In response to detecting that the user of the electronic device is no longer following the determined route and is instead located at the bookstore, the electronic device forgoes presenting directional information to the user of the electronic device (e.g., for returning to the determined route) because the contextual data satisfies the one or more criteria (e.g., because of the rainy weather and because the current location of the user is at the bookstore).

FIG. 7 is a flow diagram illustrating a method in which an electronic device presents directional information corresponding to navigation directions from a first location to a second location along a determined route and selectively redirects a user back to the determined route using contextual data when detecting that the electronic device is no longer following the determined. The method 700 is optionally performed at electronic devices such as device 100, device 300, or device 500 as described above with reference to FIGS. 1A-1B, 2-3, 4A-4B and 5A-5C. Some operations in method 700 are, optionally combined and/or order of some operations is, optionally, changed.

As described below, the method 700 provides ways in which an electronic device presents directional information corresponding to navigation directions from a first location to a second location along a determined route and selectively redirects a user back to the determined route using contextual data when detecting that the electronic device is no longer following the determined. Presenting directional information and selectively redirecting a user back to a determined route based on contextual data when detecting that the electronic device is no longer following the determined route enhances the user experience by simplifying the user interaction with the electronic device, thus reducing the number of inputs needed to exit or pause the application that is providing the navigation directions, thereby reducing power usage and improving the battery life of the electronic device.

In some embodiments, such as in FIG. 6A, method 700 is performed at an electronic device (e.g., 500) in communication with a display generation component (e.g., 504) and one or more input devices. For example, a head mounted display or device (HMD) and/or a body-mounted display or device, a mobile device (e.g., a tablet, a smartphone, a media player, or a wearable device) including wireless communication circuitry, optionally in communication with one or more of headphones and/or earbuds that optionally includes one or more cameras and/or inertial measurement units (IMU), a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, method 700 is performed at or by an automobile (e.g., at an infotainment system of an automobile having or in communication with one or more display generation components and/or input devices).

In some embodiments, while presenting directional information corresponding to navigation directions from a first location to a second location (e.g., the directional information optionally is or includes symbols, images, and/or words providing step-by-step directions navigating a user of the electronic device from the first location to the second location along a route, such as described below), such as first location 604 and second location 606 in FIG. 6A, wherein the navigation directions are based on a determined route (e.g., 608) from the first location to the second location (e.g., the navigation directions are optionally responsive to user input corresponding to a request to display the navigation directions from the first location the second location), the electronic device detects (702a) that the electronic device is no longer following the determined route,

For example, the directional information optionally includes a sequence of five symbols and/or words directing a user from work to home (e.g., “walk west on Mission Blvd.; turn right on King St.; turn left on 3rd St.; arrive at your destination on the right”). In some embodiments, the directional information include one or more of a route line, arrows, and/or waypoint indicators along the route. In some embodiments, the directional information is presented via voice navigation instructions and/or a combination of symbols, images, and/or words navigating a user from the first location the second location. In some embodiments, the directional information is displayed in an augmented reality environment and are overlaid on portions of the physical environment to which they correspond). In some embodiments, the route includes one or more determined paths of traversal—optionally determined by the electronic device—of one or more of roads, bridges, staircases, bedrooms, family rooms, lobbies, hallways, walking paths, driving lanes, bike paths, alleys, aisles, building wing, and/or doorways for reaching the second location from the first location.

For example, if the directional information is displayed and include symbols and/or words indicating to turn right on King St., however, the electronic device and/or user is detected turning left on King St., it is optionally determined that the electronic device and/or user is no longer following the determined route. Determining that the electronic device and/or user is no longer following the route is optionally in accordance with a determination that the electronic device and/or user has deviated more than a threshold distance (e.g., 0.1, 0.5, 1, 3, 5, 10, 30, 50, 100 or 1000 meters) from the one or more determined paths or traversal and/or the route.

Determining that the electronic device and/or user is no longer following the route is optionally in accordance with a determination that the electronic device and/or user is moving in a direction different from the determined or suggested direction for a given path of traversal and/or the route for reaching the second location from the first location. Determining that the electronic device and/or user is no longer following the route is optionally in accordance with a determination that the electronic device and/or user is no longer moving (and/or has not moved for at least a time threshold such as 0.1, 0.3, 0.5, 1, 3, 5, 10, 30, 60, 240 and/or 480 minutes) in the determined or suggested direction for a given path of traversal and/or the route for reaching the second location from the first location. Determining that the electronic device and/or user is no longer following the route is optionally in accordance with a determination that the electronic device and/or user is no longer oriented in a direction towards and/or aligned with (and/or has not been so oriented for at least a time threshold such as 0.1, 0.3, 0.5, 1, 3, 5, 10, 30, 60, 240 and/or 480 minutes) the determined or suggested direction for a given path of traversal and/or the route for reaching the second location from the first location.

In some embodiments, in response to detecting that the electronic device (e.g., 500) is no longer following the determined route (702b), such as the current location 602 of the electronic device in FIG. 6C, and in accordance with a determination that contextual data (e.g., for example, contextual data optionally includes a variety of information associated with the context of the environment associated with the determined route and/or the user), other than a location of the electronic device relative to the determined route, does not satisfy one or more criteria (e.g.), the electronic device (e.g., 500) presents (702c) (e.g., displaying, via the display generation component) the directional information directing a user of the electronic device back to the determined route from the first location to the second location.

For example, the directional information directing a user of the electronic device back to the determined route optionally include the same, additional, and/or updated directional information directing the user of the electronic device from the present location of the user to the second location. For example, the electronic device optionally indicates (e.g., visually and/or audibly) that the electronic device and/or user have deviated from the determined route, and/or provides (e.g., visually and/or audibly) directions for how the electronic device and/or user can move back onto the determined route.

In some embodiments, the contextual data includes the present weather conditions, the time of day, hazardous objects along the determined route, and/or potential threats (e.g., stray animals, or threating people) along the determined route. In some embodiments, the contextual data includes historical data associated with the user such as the user's prior visits to specific restaurants and/or retail establishments. Additional details about the contextual data will be described later.

In some embodiments, the one or more criteria include a criterion that is satisfied when the contextual data indicates that it is the user's dinner time and that the user's deviation from the route is to the favorite restaurant of the user, which is not along the determined route. In some embodiments, the one or more criteria include a criterion that is satisfied when the contextual data indicates that the user's favorite bookstore that the user frequents regularly is nearby and the user's deviation from the route to the bookstore is not along the determined route. In some embodiments, the one or more criteria include a criterion that is satisfied when the contextual data indicates that there is a potential threat along the determined route and that the user is deviating in a direction away from the location of the potential threat.

In some embodiments, in response to detecting that the electronic device (e.g., 500) is no longer following the determined route and in accordance with a determination that the contextual data satisfies the one or more criteria (e.g., one or more of the above-described criteria are satisfied), the electronic device (e.g., 500) forgoes (702d) presenting the directional information directing the user of the electronic device back to the determined route. In some embodiments, forgoing presenting the directional information optionally includes pausing the application that is providing the navigation directions. In some embodiments, forgoing presenting the directional information optionally includes exiting and/or closing and/or ceasing display of the application that is providing the navigation directions. Selectively redirecting a user back to a determined route based on contextual data enhances the user experience by simplifying the user interaction with the electronic device, thus reducing the number of inputs needed to exit or pause the application that is providing the navigation directions, thereby reducing power usage and improving the battery life of the electronic device.

In some embodiments, the contextual data (e.g., 640) includes information from a plurality of applications, such as applications 626a-626d in FIG. 6E. In some embodiments, the contextual data can be and/or is accessed from various sources such as from a plurality of different applications installed on the electronic device. In some embodiments, the contextual data can and/or is additionally or alternatively be accessed from a plurality of sensors such as an inertial sensor, an odometry sensor, an inertial measurement unit, altimeter, or any combination thereof. In some embodiments, the plurality of applications includes a weather application, a personal safety network application, restaurant and business review application, a timeline application that tracks the geolocation of a user, a clock application, social network application, and/or a traffic and road condition application.

In some embodiments, the contextual data includes information that provides context related to the user (e.g., behaviors and/or tendencies) of the electronic device, an event, and/or an entity. The contextual data optionally includes a variety of information associated with the context of the environment associated with the determined route and/or the user. In some embodiments, the contextual data is used to predict an action of the user. For example, contextual data is accessed from a restaurant and business review application which includes information that the user's favorite restaurant is located two-blocks away from the determined route. Using contextual data from an odometry sensor to determine that the user is no longer following the determined route and that the user is navigating away from the determined route and toward the user's favorite restaurant, the electronic device optionally forgoes presenting the directional information directing the user of the electronic device back to the determined route, because the electronic device predicts that the user is going to the restaurant to have dinner. Obtaining contextual data from a plurality of applications improves the accuracy of determining whether the contextual data satisfies the one or more criteria, or does not satisfy one or more criteria, and provides a more consistent presentation of directional information, thereby reducing errors in interaction and simplifying user interaction with the electronic device.

In some embodiments, a visual sensor, an inertial sensor, an odometry sensor, an inertial measurement unit, or any combination thereof, are included in one or more headphone devices worn by the user and determining a respective location of the electronic device (e.g., 500) relative to the determined route (e.g., 608) is based on data from the visual sensor, the inertial sensor, the odometry sensor, the inertial measurement unit, or any combination thereof, such as VIO data 628 and/or inertial measurement unit (IMU) data 630 in FIG. 6E. In some embodiments, the visual sensor, the inertial sensor, and the odometry sensor are optionally integrated together to form a VIO device. In some embodiments, the visual sensor detects and/or uses images to determine the presence, orientation, and/or accuracy of surrounding objects in an environment. In some embodiments, the inertial sensor is used to transduce inertial force into measurable electrical signals to measure acceleration, inclination, and/or vibration of a device such as the headphone device. In some embodiments, the odometry sensor is used to determine a change in position relative to a known position.

For example, as a user navigates along the determined route, at any point along the determined route, the combination of the visual sensor, the inertial sensor, and the odometry sensor is optionally used to determine a current location of the electronic device, optionally relative to the determined route. In some embodiments, the inertial measurement unit is configured to detect motion and/or orientation of the electronic device. In some examples, a specific orientation of the electronic device and/or a pattern of movement of the electronic device is determined, which is indicative of a user walking/moving, and/or not moving along the determined route while using the electronic device. In some embodiments, data from the visual sensor, the inertial sensor, the odometry sensor, the inertial measurement unit, or any combination thereof is contextual data which is used to determine whether to continue presenting directional information or to forego presenting directional information in response to determining whether the contextual data satisfies one or more criteria. Determining a respective location of the electronic device using a combination of a visual sensor, an inertial sensor, an odometry sensor, and/or an inertial measurement unit improves the accuracy in determining the respective location of the electronic device, thereby reducing errors in presenting or foregoing the presentation of the directional information which simplifies user interaction and thus reducing the power usage and improving battery life of the electronic device.

In some embodiments, the odometry sensor is configured to be used to determine a change in position (e.g., of the user and/or the electronic device) relative to a known respective position relative to the determined route, such as the known position of the current location 602 of the electronic device in FIG. 6C. In some embodiments, the odometry sensor includes one or more motion sensors which estimate a change in position relative to a known position over time. In some embodiments, the known respective position of the electronic device is continuously tracked using global positioning system (GPS) satellites, cellular towers, WIFI, and/or any other wireless communication systems. For example, the electronic device optionally includes GPS receivers that are configured to receive signals emitted by satellites which are optionally used to determine the known respective position of the electronic device at any point in time and/or a known respective position relative to any other location (e.g., the determined route, nearby stores, and/or any other destination). With the known respective position of the electronic device, the odometry sensor is optionally used to determine any changes in position of the electronic device relative to the known respective position.

In some embodiments, using data from the odometry sensor, the change in position relative to the known respective position is measured. Thus, optionally using the odometry sensor to determine the change in position relative to the known position improves the accuracy of determining a respective position of the user and/or the electronic device at any given point in time. In some embodiments, the determined route includes one or more known respective positions (e.g., from a database or a map) where the odometry sensor is optionally used to determine a change in position relative to the one or more known respective positions. For example, the determined route includes a first known respective location, a second known respective location, and a third known respective location along the route, which respectively corresponds to a starting location, a historical landmark, and a final destination. In this example, while detecting that the electronic device is at the historical landmark and navigating in a direction away from the historical, the odometry sensor is used to determine a change in position of the electronic device relative to the historical landmark and/or the final destination (e.g., relative to the known positions of those landmarks), and thus determine a current estimated position for the electronic device.

In some embodiments, the odometry sensor is used to determine a velocity at which the user of the electronic device moves relative to a known position. For example, while detecting that the electronic device is navigating past a shopping center along the determined route, the electronic device is detected as no longer following the determined route at a position proximate to the shopping center along the determined route. The odometry sensor is optionally used to estimate a current position of the electronic device relative to the shopping center so that the electronic device can be and/or is routed back to the determined route. Using an odometry sensor to determine a change in position relative to a known position improves the accuracy in determining the current position of the electronic device, thereby accurately presenting directional information if directing the user of the electronic device back to the determined route which simplifies user interaction and thus reducing the power usage and improving battery life of the electronic device.

In some embodiments, in accordance with a determination that a current location of the electronic device relative to the determined route is indoors, data from the visual sensor, the inertial sensor, the odometry sensor, the inertial measurement unit, or any combination thereof is used to determine the respective location of the electronic device along the determined route, such as the electronic device entering building 612 in FIG. 6C. In some embodiments, the visual sensor, the inertial sensor, the odometry sensor, the inertial measurement unit, or any combination thereof is used to determine a respective position of a user of the electronic device in an indoor environment and/or an outdoor environment. In some embodiments, GPS satellites, cellular towers, WIFI, and/or any other wireless communication systems is used to determine a respective position of a user of the electronic device in an indoor environment and/or an outdoor environment.

In some embodiments, in accordance with a determination that a current location of the electronic device relative to the determined route is indoors, data from the visual sensor, the inertial sensor, the odometry sensor, the inertial measurement unit, or any combination thereof is used to determine the respective location of the electronic device along the determined route without using data from the GPS satellites, cellular towers, or from WIFI. In some embodiments, in accordance with a determination that a current location of the electronic device relative to the determined route is outdoors, data from the visual sensor, the inertial sensor, the odometry sensor, the inertial measurement unit, GPS satellites, cellular towers, WIFI, or any combination thereof is used to determine the respective location of the electronic device along the determined route.

For example, if the determined route includes presenting directional information that leads the user of the electronic device through a main lobby of a building to reach the second location in the building, data from the visual sensor, the inertial sensor, the odometry sensor, the inertial measurement unit are used to determine the respective location of the electronic device along the interior of the building without using data from the GPS satellites, cellular towers, or from WIFI. Thus, the visual sensor, the inertial sensor, the odometry sensor, and/or the inertial measurement unit, are optionally used to determine the respective location of the electronic device when the user enters the main lobby of the building because data from the GPS satellites, cellular towers, and/or WIFI may be unavailable to track and monitor the respective position of the electronic device in an indoor environment.

In some embodiments, in accordance with a determination that a current location of the electronic device relative to the determined route is not indoors (e.g., outdoors), data from the visual sensor, the inertial sensor, the odometry sensor, the inertial measurement unit, or any combination thereof is used to determine the respective location of the electronic device along the determined route. Using the inertial sensor, the odometry sensor, the inertial measurement unit, or any combination for determining a current location of the user in an indoor environment improves the accuracy in determining the current position of the electronic device, thereby accurately presenting directional information or foregoing the presentation of the directional information which simplifies user interaction and thus reducing the power usage and improving battery life of the electronic device.

In some embodiments, in accordance with a determination that a current location of the electronic device relative to the determined route corresponds to a waypoint along the determined route, data from the visual sensor, the inertial sensor, the odometry sensor, the inertial measurement unit, or any combination thereof is used for determining the current location of the electronic device relative to the determined route, such as VIO data 628 and/or inertial measurement unit (IMU) data 630 in FIG. 6E. In some embodiments, in accordance with a determination that the current location of the electronic device relative to the determined route does not correspond to a waypoint along the determined route, data from the visual sensor and the odometry sensor is not used for determining the current location of the electronic device relative to the determined route. In some embodiments, the waypoint is an intermediate point and/or place along the determined route. In some embodiments, the user of the electronic device provides input to designate specific landmarks and/or specific locations as waypoints.

For example, a waypoint is optionally a reference point such as a natural landmark (e.g., a mountain, a hill, a valley, a body of water, a rock formation, a waterfall, and/or a landmark region) or a manmade landmark made by humans (e.g., a building, a monument, a bridge, a reservoir, and/or other manmade landmark). In one example, a user provides input to designate the bridge and the reservoir as waypoints. In some embodiments, at a waypoint that corresponds to a current location of the electronic device along the determined route (e.g., the current location of the electronic device is determined to be within a threshold distance of the waypoint, such as 0.1, 0.5, 1, 3, 5 or 10, meters), data from the visual sensor, the inertial sensor, the odometry sensor, the inertial measurement unit, or any combination thereof is used to determine the current location of the electronic device relative to the determined route and/or the waypoint.

For example, at an indoor mall, directional information presented which directs the user from the front main entrance to the Apple store along a determined route. Locations within the indoor mall such as a Christmas tree, cellular phone kiosk, and an elevator located on the first floor are optionally designated by the user of the electronic device as waypoints. Upon entering the front entrance, as the user walks near the Christmas tree it is determined that the current location of the user of the electronic device corresponds to a waypoint (e.g., Christmas tree). In response to determining that the current location of the electronic device corresponds to the waypoint (e.g., Christmas tree), data from the visual sensor, the inertial sensor, the odometry sensor, the inertial measurement unit, or any combination thereof is used to determine the current location of the electronic device relative to the determined route. As the user walks past the Christmas tree in a direction towards the elevator which is located on the opposite side of the indoor mall, it is determined that the current location of the user of the electronic device does not corresponds to any waypoints because the current location of the user of the electronic device is beyond a threshold distance to a nearest waypoint (e.g., is between waypoints). Thus, at such locations, data from the visual sensor and the odometry sensor is not used to determine the current location of the electronic device relative to the determined route.

When the user reaches the cellular phone kiosk, data from the visual sensor, the inertial sensor, the odometry sensor, the inertial measurement unit, or any combination thereof is used to determine the current location of the electronic device relative to the determined route. From the cellular phone kiosk, the user is directed to the elevator which leads the user to the Apple store that is located on the second floor of the indoor mall. In some embodiments, at a current location that does not correspond to a waypoint (e.g., in between waypoints), data from the visual sensor and the odometry sensor is not used for determining the current location of the electronic device relative to the determined route, however, data from the inertial sensor and/or the inertial measurement unit is optionally used for determining the current location of the electronic device relative to the determined route. Using data from the visual sensor, inertial sensor, the odometry sensor, the inertial measurement unit, or any combination thereof at waypoints improves the accuracy of relocalization, thus reducing the number of inputs needed determine the current location of the electronic device relative to the determined route, thereby reducing power usage and improving the battery life of the electronic device.

In some embodiments, one or more locations of one or more waypoints along the determined route (e.g., 608) are determined based on data from the visual sensor, the inertial sensor, the odometry sensor, the inertial measurement unit, or any combination thereof used to determine a current location of the electronic device relative to a starting location of the determined route, such as VIO data 628 and/or inertial measurement unit (IMU) data 630 in FIG. 6E. In some embodiments, the determined route is from the first location to the second location. In some embodiments, the determined route includes one or more locations of one or more waypoints where the waypoints are determined based on data from the visual sensor, the inertial sensor, the odometry sensor, the inertial measurement unit, or any combination thereof. The one or more locations of the one or more waypoints, the first location, and/or the second location is optionally used to determine the current location of the user of the electronic device as the user navigates along the determined route.

For example, as the user leaves home to navigate along the determined route to a bookstore, data from the visual sensor, the inertial sensor, the odometry sensor, the inertial measurement unit, or any combination is used to determine one or more locations of one or more waypoints along the determined route. At any point in time, the current location of the electronic device is tracked and the current location is optionally determined along the determined route relative to the waypoints, the first location (e.g., home) and/or a second location (e.g., bookstore) of the determined route. In some embodiments, a current location of the electronic is determined relative to the starting position (e.g., a known position, as described earlier) in a manner similar to the manner described above where in accordance with a determination that the electronic device location corresponds to the one or more waypoints, data from the visual sensor, the inertial sensor, the odometry sensor, the inertial measurement unit, or any combination thereof is used to determine the deviation of the current location of the electronic device from the one or more waypoints, and thus relative to the determined route. By anchoring waypoints along the determined path to initial known location, a current position of the electronic device relative to the determined route can be accurately determined, thus reducing the number of inputs needed determine the current position of the electronic device relative to the determined route, thereby accurately presenting directional information or foregoing the presentation of the directional information which simplifies user interaction and thus reducing the power usage and improving battery life of the electronic device.

In some embodiments, in accordance with a determination that a current portion of the determined route includes a vertical change in position from a first altitude position to a second altitude position, such as navigating to the 40th floor of building 612 in FIG. 6D, the electronic device (e.g., 500) forgoes using data from one or more of the visual sensor, the inertial sensor, the odometry sensor, or the inertial measurement unit to determine the current location of the electronic device relative to the determined route, and the electronic device uses data from an altimeter (e.g., 638) to determine the current location of the electronic device relative to the determined route, wherein data from the visual sensor, the inertial sensor, the odometry sensor, and/or the inertial measurement unit is used again by the electronic device to determine the current location of the electronic device relative to the determined route when the electronic device reaches the second altitude position.

In one example, a vertical change in position from a first altitude position to a second altitude position includes taking an elevator from a main lobby floor in a building to a different floor in the building (e.g., 2nd floor, 5th floor, 10th floor, 20th floor, 40th floor, or 80th floor). In some embodiments, in accordance with a determination that a current portion along the determined route includes a vertical change that satisfies a threshold distance (e.g., such as 0.01, 0.1, 0.5, 1, 1.5, 3, 5, 10, 30, 50, 100 or 1000 meters), the electronic device forgoes using data from one or more of the visual sensor, the inertial sensor, the odometry sensor, or the inertial measurement unit to determine the current location of the electronic device relative to the determined route, and uses data from an altimeter to determine the current location of the electronic device relative to the determined route.

In some embodiments, in accordance with a determination that one or more portions of the determined route includes a change in horizontal position of the electronic device and/or user less than a change in a vertical position by a threshold distance (e.g., such as 0.1, 0.5, 1, 1.5, 3, 5, 10, 30, 50, 100 or 1000 meters), forgoing using data from one or more of the visual sensor, the inertial sensor, the odometry sensor, or the inertial measurement unit to determine the current location of the electronic device relative to the determined route, and using data from an altimeter to determine the current location of the electronic device relative to the determined route, wherein data from the visual sensor, the inertial sensor, the odometry sensor, and/or the inertial measurement unit is used again to determine the current location of the electronic device relative to the determined route when the change in horizontal position of the electronic device and/or user is greater than a change in a vertical position by the threshold distance.

For example, when the user of the electronic device uses the stairway to walk from a first level floor to a second level floor where the change in horizontal position is 2 meters and the change in vertical position is 3.5 meters, data from the altimeter is used to determine the current location of the electronic device relative to the determined route because the change in horizontal position is less than the change in the vertical position by a threshold distance of 1.5 meters. In the example, when the data from the altimeter is used, the visual sensor, the inertial sensor, the odometry sensor, or the inertial measurement unit is deactivated and the data is not used to determine the current location of the electronic device relative to the determined route. When the electronic device determines that there is a change in altitude along the determined route, data from an altimeter is optionally used to determine the current location of the electronic device instead of data from the visual sensor, the inertial sensor, the odometry sensor, or the inertial measurement.

In some embodiments, the altimeter measures a current altitude of the electronic device. In some embodiments, the altimeter is a pressure altimeter which approximates altitude above sea level by measuring atmospheric pressure. In some embodiments, the altimeter is a radio altimeter which measures absolute altitude (distance above land or water) based on the time required for a radio wave signal to travel from an electronic device to the ground and back to the electronic device. In some embodiments, in accordance with a determination that a current portion of the determined route does not include a vertical change in position from a first altitude position to a second altitude position, data from one or more of the visual sensors, the inertial sensor, the odometry sensor, or the inertial measurement unit is used to determine the current location of the electronic device relative to the determined route.

In some embodiments, in accordance with a determination that a current portion of the determined route does not include a vertical change in position from a first altitude position to a second altitude position, data from the altimeter is not used to determine the current location of the electronic device. By not using data from the visual sensor, the inertial sensor, the odometry sensor, or the inertial measurement unit and instead using an altimeter to determine the current location of the electronic device relative to the determined route where there is a vertical change in position along the determined route improves the accuracy of determining the current position of the electronic device, thus reducing the number of inputs needed determine the current position of the electronic device relative to the determined route, thereby simplifying user interaction and thus reducing the power usage and improving battery life of the electronic device.

In some embodiments, in response to detecting that the electronic device (e.g., 500) is no longer following the determined route and in accordance with the determination that the contextual data (e.g., 640) satisfies the one or more criteria, the electronic device presents updated navigation information directing the user of the electronic device to an updated location not included in the determined route, such as presenting the user of the electronic device with updated navigation information directing the user of the electronic device to building 612 in FIG. 6C. For example, determining that the electronic device and/or user is no longer following the determined route is optionally based on detecting that the electronic device and/or user is moving in a direction that is inconsistent with the directional information presented to the user for a given location along the determined route.

For example, the one or more criteria include a criterion that is satisfied when the contextual data indicates that the user's favorite author recently released a new book and that the user's deviation from the determined route is to a bookstore in a shopping mall that is not along the determined route. Because the electronic device is no longer following the determined route and that the contextual data satisfies the one or more criteria, the user of the electronic device is optionally presented with updated navigation information directing the user of the electronic device to the bookstore, which was optionally not included in the original determined route. In some embodiments, the user of the electronic device is presented with updated navigation information directing the user of the electronic device to the updated location without requiring user input.

In some embodiments, the updated navigation information includes symbols, images, and/or words providing step-by-step directions navigating a user of the electronic device from a current location at which the electronic device is detected as no longer following the determined route to the updated location. In some embodiments, the updated navigation information is displayed in an augmented reality environment and are overlaid on portions of the physical environment to which they correspond. In some embodiments, while detecting that the current location of the user of the electronic device is at the updated location (e.g., bookstore), the user of the electronic device is presented with updated navigation information directing the user of the electronic device from the updated location (e.g., bookstore) to the determined route. In some embodiments, presenting updated navigation information directing the user of the electronic device from the updated location (e.g., bookstore) to the determined route is in accordance with the determination that the contextual data satisfies one or more criteria. In some embodiments, the one or more criteria include a criterion that is satisfied when the contextual data indicates that the user has been present at the updated location for at least a threshold time (e.g., 15, 30, 60, 120, 240, and/or 480 minutes).

In some embodiments, the one or more criteria include a criterion that is satisfied when the contextual data indicates that the user has performed an action and/or activity (e.g., shopped for merchandise, met with a friend, watched a sporting event, inquired about a product or service, and/or ate dinner). In some embodiments, in response to detecting that the electronic device is no longer following the determined route and in accordance with the determination that the contextual data does not satisfy one or more criteria, the user is presented with directional information directing the user of the electronic device back to the determined route. Directing a user to the updated location based on detecting that the user is no longer following the determined route enhances the user experience by simplifying the user interaction with the electronic device, thus reducing the number of inputs needed to present navigation directions to the updated location, thereby reducing power usage and improving the battery life of the electronic device.

In some embodiments, the updated navigation information includes voice navigation instructions directing the user to the updated location, such as directing the user to building 612 in FIG. 6C. In some embodiments, the updated navigation information is presented via voice navigation instructions and/or a combination of symbols, images, and/or words navigating a user from the current location to the updated location. For example, while navigating to the updated location (e.g., bookstore on third floor of shopping mall), the electronic device is configured to generate audio feedback such as voice navigation instructions as the user navigates to the bookstore. In some embodiments, the updated navigation information is presented in response to satisfying the one or more criteria as discussed above and does not require input by the user of the electronic device. In some embodiments, voice navigation instructions are presented without requiring input by the user of the electronic device. Including voice navigation instructions with the updated navigation information to direct a user to the updated location simplifies user interaction with the electronic device, thus reducing the number of inputs needed to interact with the electronic while navigating to the updated location, thereby reducing power usage and improving the battery life of the electronic device.

In some embodiments, the electronic device (e.g., 500) uses pre-mapped data to direct the user to the updated location, such as directing the user to building 612 in FIG. 6C. In some embodiments, the pre-mapped data includes data from the visual sensor, the inertial sensor, the odometry sensor, and/or the inertial measurement obtained from past occurrences at which the user of the electronic device traversed along the determined route. In some embodiments, the pre-mapped data is accessed from remote servers that stores data associated with the with the determined route. In some embodiments, the pre-mapped data is accessed from remote servers that stores data that is associated with the determined route and is not obtained from past occurrences at which the user of the electronic device traversed along the determined route. The pre-mapped data optionally includes three-dimensional (3D) location data (e.g., x, y, z spatial coordinates) that precisely maps the external environment and internal environment which is accessible by the electronic device as the user navigates along the determined route.

For example, while navigating along a determined path in Embarcadero in San Francisco which the user of the electronic device previously visited 5 years ago while on vacation, the electronic device fetches relevant pre-mapped data as the user of the electronic device navigates along the determined route to reach a waterfront restaurant in Embarcadero for dinner. Using the pre-mapped data reduces latency and delays when communication data from other sources are not available (e.g., cellular towers, and/or WIFI). In some embodiments, when updated navigation information is presented to the user to direct the user of the electronic device to the updated location (e.g., bookstore on third floor of shopping mall), the electronic device optionally uses existing pre-mapped data. In some embodiments, the pre-mapped data is a collection of data that is used to pre-map both exterior environments and interior environments such as roads, bridges, staircases, bedrooms, family rooms, lobbies, hallways, walking paths, driving lanes, bike paths, alleys, aisles, building wing, and/or doorways. In some embodiments, the pre-mapped data includes metadata and/or data accessed from maps generated from prior navigation sessions. Using pre-mapped data to direct the user to the updated location reduces computational resources performed by the electronic device, thereby reducing power usage and improving the battery life of the electronic device.

In some embodiments, data from a visual sensor, an inertial sensor, an odometry sensor, an altimeter, or any combination thereof, is used to direct the user to the updated location, such as VIO data 628, inertial measurement unit (IMU) data 630, and/or altimeter data 638 in FIG. 6E. In some embodiments, the visual sensor uses images to determine the presence, orientation, and accuracy of surrounding objects in an environment. In some embodiments, the inertial sensor is used to transduce inertial force into measurable electrical signals to measure acceleration, inclination, and vibration of a device such as the headphone device. In some embodiments, the odometry sensor is used to determine a change in position relative to a known position. In some embodiments, the altimeter measures a current altitude of an electronic device.

For example, while navigating to the updated location, the visual sensor optionally uses image data of the updated location and the surrounding environment to calculate an approximate distance and time it takes to reach the updated location. Data from the inertial sensor is optionally used to determine the speed at which the user is travelling along the path to reach the updated location. As the user progresses toward the updated location, data from the odometry sensor is used to calculate determine the current position of the user of the electronic device relative to updated location and/or any other locations along the path. Data from the altimeter is optionally used to determine changes in altitude (e.g., climbing stairs, using an elevator, and/or using an escalator) as the user navigates to the updated location.

The combination of the data from the visual sensor, the data from the inertial sensor is, the data from the odometry sensor, and/or data from the altimeter is optionally used in to direct the user the updated location while considering changes in the speed, acceleration, and the specific path the user takes to reach the updated location. Using a visual sensor, an inertial sensor, an odometry sensor, an altimeter, or any combination thereof to direct the user to the updated location improves the accuracy of determining a current location of the electronic to detect whether the electronic device is no longer following the determined route, thus reducing the number of inputs needed to adjust for errors that potentially occurs, thereby reducing power usage and improving the battery life of the electronic device.

In some embodiments, while navigating along the determined route, the electronic device and/or headphones worn by the user provides audio feedback that indicates a location of the electronic device relative to the determined route. In some embodiments, the audio feedback is a sound of a heartbeat or other periodic audio output that is audible to indicate that the user is navigating along the determined route. In some embodiments, audio feedback is provided without requiring user input. In some embodiments, a rate of the audio output increases from a first frequency (e.g., 20 units per minute) at the first location (e.g., starting point) to a second frequency (e.g., 1000 units per minute) as the user gets closer to the second location (e.g., final destination). In some embodiments, the rate of the periodic audio output decreases from a first frequency at the first location to a second frequency as the user gets closer to the second location.

In some embodiments, in accordance with a determination that the electronic device is no longer following the determined route, audio feedback is provided to indicate that the user of the electronic device is deviating from the determined route. For example, while navigating from the first location to the second location, it is determined that the electronic device has deviated more than a threshold distance of 1 meter from the determined route. In response to detecting the deviation from the determined route, audio output such as a heartbeat at a first frequency of 50 beats per minute is optionally provided. As the user continues to deviate at a further distance away from the determined route, the audio output changes frequencies (e.g., increases to a frequency of 75 beats per minute or decreases to a lower frequency of 25 beats per minute) based on the deviated distance with respect to the determined route.

For example, the further the distance that the user of the electronic device is from the determined route, the frequency changes to a higher frequency or a lower the frequency based on the distance that the user travels away from the determined route. In some embodiments, while the user of the electronic device navigates along the determined route and does not deviate from the determined route (e.g., the electronic device and/or user has not deviated more than a threshold distance such as 0.1, 0.5, 1, 3, 5, meters from the determined route), the audio feedback is not provided. In some embodiments, while the user of the electronic device navigates along the determined route and does not deviate from the determined route, the audio feedback is provided at first frequency and remains at the first frequency until it is detected that the electronic device is no longer following the determined route. In some embodiments, if it is detected that the user of the electronic device is no longer navigating along the determined route, the audio feedback ceases. In some embodiments, the audio feedback is any sound and have one or more characteristic of sound such as volume, intensity, and/or pitch.

In some embodiments, one or more characteristic of sound optionally changes in response to detecting that the electronic device is no longer following the determined route. For example, in response to detecting the deviation from the determined route, audio output at a first frequency and a corresponding first volume is provided. As the user continues to deviate at a further distance away from the determined route, the audio output changes frequencies and volume (e.g., increases or decreases) to a second frequency and a second volume based on the deviated distance with respect to the determined route. Selectively providing audio feedback while a user navigates along the determined route simplifies the user interaction with the electronic device by providing the user with positive reinforcement that informs the user about whether or not the user is navigating along the determined route, thus reducing the number of inputs needed to present information about whether the user is navigating along the correct route, thereby reducing power usage and improving the battery life of the electronic device.

In some embodiments, while presenting the directional information corresponding to the navigation directions from the first location (e.g., starting point) to the second location (e.g., final destination) and in accordance with a determination that the electronic device is following the determined route, the electronic device and/or headphones worn by the user generates voice navigation instructions directing the user along the determined route, such as determined route 608 in FIG. 6A. In some embodiments, generating the voice navigation instructions is performed automatically by the electronic device without requiring user input. In some embodiments, determining that the electronic device and/or user is following the route is in accordance with a determination that the electronic device and/or user has not deviated more than a threshold distance (e.g., 0.1, 0.5, 1, 3, 5, meters) from the one or more determined paths or traversal and/or the route.

In some embodiments, while presenting the directional information corresponding to the navigation directions from the first location to the second location and in accordance with a determination that the electronic device is no longer following the determined route, the electronic device and/or headphones worn by the user ceases to generate voice navigation instructions. In some embodiments, ceasing the generation of the voice navigation instructions is performed automatically by the electronic device without requiring user input. For example, while navigating from the first location to the second location, the electronic device is configured to generate audio feedback such as voice navigation instructions to direct the user along the determined route. In some embodiments, while the electronic device presents directional information, the voice navigation concurrently generates audio of a corresponding text that is presented on the directional information.

For example, while navigating along the determined route, voice navigation instructions are presented to the user of the electronic device directing the user to the Apple store located on the second floor in the indoor shopping mall (e.g., “enter via main entrance on Market Street; walk 60 meters northbound toward the escalator located near the Christmas tree; take elevator to the second floor; walk 15 meters southbound; arrive at Apple store on your right hand side”). In some embodiments, when detecting that the user and/or the electronic device is no longer following the determined route, the electronic device is configured to cease generating the voice navigation instructions to provide positive reinforcement and to optionally not restrict the user's autonomy of freely exploring routes beyond the determined route.

For example, if the user deviates from the determined route and takes a detour to a coffee shop that is not along the determined route, the electronic device ceases to generate voice navigation instructions, whether to re-route the user back to the determined route and/or to direct the user to the coffee shop. Selectively generating voice navigation instructions or ceasing to generate voice navigation instructions based on whether the electronic device and/or user is following the determined route enhances the user experience by simplifying the user interaction with the electronic device, thus reducing the number of inputs needed to exit or pause the application that is providing the voice navigation instructions, thereby reducing power usage and improving the battery life of the electronic device.

In some embodiments, after detecting that the electronic device (e.g., 500) is no longer following the determined route and ceasing the generating of the voice navigation instructions, the electronic device detects that the electronic device has returned to the determined route, and in response to detecting that the electronic device has returned to the determined route, the electronic device reactivates the voice navigation instructions directing the user along the determined route, such as entering building 620 in FIG. 6B when detecting that the electronic device has returned to the determined route. In some embodiments, determining that the electronic device and/or user has returned to the determined route is in accordance with a determination that the electronic device and/or user is within a threshold distance (e.g., 0.1, 0.5, 1, 3, 5, meters) from the determined route.

For example, in response to detecting that the electronic device has returned to the determined route (e.g., the electronic device is within a threshold distance of 3 meters from the determined route), the electronic device is configured to reactivate the audio feedback such as the voice navigation instructions to continue directing the user along the determined route determined route. In some embodiments, in response to detecting that the electronic device has not returned to the determined route (e.g., the electronic device is beyond a threshold distance of 3 meters from the determined route), voice navigation instructions remain inactive until it is determined that the electronic device has returned to the determined route. In some embodiments, determining that the electronic device has returned to the determined route is optionally in accordance with a determination that a current distance of the electronic device and/or user to the determined route decreases as the user navigates toward the determined route.

In some embodiments, determining that the electronic device has returned to the determined route is optionally in accordance with a determination that the electronic device and/or user is oriented in a direction toward the determined route (e.g., within a range of angles such as 1, 3, 5, 10, 30 and/or or 45 degree angles, of the direction of the determined route) and/or is moving in a direction toward the determined route. In some embodiments, ceasing and/or reactivating the voice navigation instructions is performed automatically by the electronic device without requiring user input. Selectively reactivating the voice navigation instructions in response to determining that the has user returned to the determined route enhances the user experience by simplifying the user interaction with the electronic device, thus reducing the number of inputs needed to reactivate the voice navigation instructions after deciding to return to the determined route, thereby reducing power usage and improving the battery life of the electronic device.

In some embodiments, while navigating along the determined route, the electronic device generates feedback that is based on determining that the electronic device is following the determined route wherein the feedback indicates that the electronic device is following the determined route, such as navigating along the determined route 608 in FIG. 6A. In some embodiments, determining that the electronic device and/or user is following the route is in accordance with a determination that the electronic device and/or user has not deviated more than a threshold distance (e.g., 0.1, 0.5, 1, 3, 5, meters) from the one or more determined paths or traversal and/or the route. In some embodiments, the generated feedback is audio feedback, and/or visual feedback. In some embodiments, audio feedback is sound such as a heartbeat or other audio output that is audible to indicate that the user is navigating along the determined route. In some embodiments, in response to detecting that the electronic device remains on the determined route, the audio feedback and/or visual feedback is provided without requiring user input. In some embodiments, the audio feedback includes a corresponding rate with a respective frequency (e.g., 1 unit per minute, 5 units per minute, 20 units per minute, 50 units per minute, 100 units per minute, 500 units per minute, 1000 units per minute) that remains constant or varies as the electronic device navigates along the determined route.

In some embodiments, the audio feedback includes one or more sound characteristics such as frequency, volume, intensity, and/or pitch that changes in response to determining that the electronic device is following the determined route and/or getting closer to the second location. For example, a respective frequency of the audio feedback increases from a first frequency to a second frequency as the user gets closer to reaching the second location (e.g., final destination). In some embodiments, visual feedback is presented to provide positive feedback and/or accolades to the user indicating that the user of the electronic device is following the determined route. For example, the visual feedback optionally includes visual representation of likes, hearts, emoticon, and/or other symbols providing positive feedback while the electronic device is following the determined route. Selectively providing feedback while a user navigates along the determined route simplifies the user interaction with the electronic device, thus reducing the number of inputs needed to present information to indicate whether the user is navigating along the determined route, thereby reducing power usage and improving the battery life of the electronic device.

In some embodiments, in response to detecting that the electronic device is no longer following the determined route, the electronic device ceases the generation of the feedback, such as navigating away from the determined route 608 and along path 622 to building 610 in FIG. 6B. For example, in response to the detecting that the electronic device is no longer following the determined route, feedback such as audio feedback and/or visual feedback is no longer generated and provided to the user of the electronic device. In some embodiments, the audio feedback and/or visual feedback ceases without requiring user input. Ceasing the generation of the feedback in response to detecting that the electronic device is no longer following the determined route simplifies the user interaction with the electronic device, thus reducing the number of inputs needed to verify whether the user is no longer following the determined route, thereby reducing power usage and improving the battery life of the electronic device.

In some embodiments, the contextual data includes data from a visual sensor, an inertial sensor, an odometry sensor, an inertial measurement unit, or any combination thereof, that is used for determining a respective direction to which the user is looking, such as VIO data 628 and/or inertial measurement unit (IMU) data 630 in FIG. 6E. The respective direction to which the user is looking is optionally used to determine the updated location to direct the user of the electronic device. Determining the respective direction to which the user is looking is optionally in accordance with a determination that the contextual data includes data from the visual sensor corresponding to a surrounding environment of the respective area to which the user is looking (e.g., café, bookstore, restaurant, shopping mall, and/or gym). Determining the respective direction to which the user is looking is optionally in accordance with a determination that that the contextual data includes data from the inertial sensor and/or IMU unit indicating that the electronic device is accelerating toward the respective direction to which the user is looking. Determining the respective direction to which the user is looking is optionally in accordance with a determination that that the contextual data includes data from the odometry sensor corresponding to a change in direction of the body of the user from a position along the determined route to a position that is directed toward the respective direction to which the user is looking

For example, while navigating along the determined route, the contextual data includes data from the visual sensor which includes captured images of a shopping center that is located at a location that is not along the determined route. The contextual data indicates that the user of the electronic device looking at the shopping mall wall while navigating along the determined route. The contextual data optionally includes data from the odometry sensor indicating a change in position of the user's head which is directed in a direction toward the shopping center. If the electronic device is detected navigating in a direction away from the determined route, the contextual data (e.g., visual sensor data and the odometry sensor data) is used to determine the respective direction to which the user is looking (e.g., shopping mall) and in turn determine the updated location so that updated directions are optionally presented to direct the user of the electronic device to the shopping mall. Obtaining contextual data from a visual sensor, an inertial sensor, an odometry sensor, or an inertial measurement unit improves the accuracy of determining a respective direction to which the user is looking and a predicted reason for the user's detour, thus improving the accuracy of presenting or foregoing the presentation of the directional information which simplifies user interaction and thus reducing the power usage and improving battery life of the electronic device.

In some embodiments, the contextual data includes information related to an environment associated with the determined route (e.g., 608), present weather conditions, a time of day, historical data associated with the user, information related to past behavior of the user, information related to current behavior of the user, or any combination thereof, such as contextual data 640 in FIG. 6E. In some embodiments, the contextual information includes information related to past behavior of the user such as habits and/or tenancies (e.g., time at which the user eats, types of food and/or restaurants the user enjoys, and/or how much the user tends to spend on food).

For example, while navigating along the determined route, the contextual data indicates that at 3 PM the user has a habit of dining at establishments that offers a happy hour menu. When electronic device deviates from the determined route at 3 PM, the contextual data is optionally used to predict that the user is navigating towards a dining establishment that offers a happy hour menu, and the electronic device determines whether the contextual data satisfies the one or more criteria. For example, after dining at the establishment, the contextual data indicates that the current time is 5:30 PM and that the user's favorite baseball team will be playing at 5:45 PM and that the user typically watches baseball games at a local sports bar. When the user of the electronic device leaves the dining establishment at 5:30 PM, the user of the electronic device is optionally presented with updated navigation information directing the user of the electronic device to the sports bar based on satisfying one or more criteria that includes a criterion that is satisfied when the user is walking in a direction toward the sports bar, which was optionally not included in the original determined route.

In some embodiments, if the one or more criteria is not satisfied (e.g., not walking toward the sports bar), directional information is presented which includes directions directing the user back to the determined route. Contextual data that includes various types of information improves the accuracy of determining the user's behavior using various sources of information, thus improving the accuracy of presenting or foregoing the presentation of the directional information which simplifies user interaction and thus reducing the power usage and improving battery life of the electronic device.

In some embodiments, the contextual data includes information related to one or more current behaviors of one or more people, other than the user of the electronic device, in an environment of the user, such as contextual data 640 in FIG. 6E. In one example, the current behaviors of one or more people include behavior characteristics such as whether the one or more people are confused/uncertain, confident, obstructive, reserved, shy, aggressive, hostile, and/or rude. In some embodiments, using the contextual data, the electronic device is configured to update the determined route and/or adjust the presented directional information based on the current behaviors of the one or more people in the environment of the determined route.

For example, while a user of the electronic device navigates along the determined route through an indoor shopping mall, the contextual data optionally includes information that indicates that a group of people are walking in front of the user of the electronic device. In accordance with a determination that the group of people satisfies a first set of one or more criteria (e.g., the group of people are lost, reserved, confused, and/or uncertain), the user of the electronic device is presented with directional information directing the user of the electronic device to walk around the group of people. In accordance with a determination that the group of people do not satisfy the first set one or more criteria, the user of the electronic device is presented with directional information directing the user of the electronic device is not presented with directional information directing the user of the electronic device to walk around the group of people.

In some embodiments, in accordance with a determination that a group of people satisfies a second set one or more criteria (e.g., the group of people are obstructive, aggressive, hostile, and/or rude), the user of the electronic device is presented with updated directional information directing the user of the electronic device along an updated determined route that avoids the group of people. In some embodiments, in accordance with a determination that a group of people do not satisfy the second set one or more criteria), the user of the electronic device is not presented with updated directional information directing the user of the electronic device along an updated determined route. Contextual data that includes information related to the behavior of people other than the user of the electronic device improves the accuracy of presenting or foregoing the presentation of the directional information which simplifies user interaction and thus reducing the power usage and improving battery life of the electronic device.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5J) or application specific chips. Further, the operations described above with reference to FIG. 7 are, optionally, implemented by components depicted in FIGS. 1A-1B. For example, detecting operation 702a and presenting operation 702c are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is capturing and displaying content and location information. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, capturing information related to past behaviors and tendencies of a user can be used to present directional information to the user. Accordingly, use of such personal information data enables users to use electronic devices to view content. Further, other uses for personal information data that benefit the user are also contemplated by the present disclosure. For instance, contextual data may be used to enhance the presentation of directional information.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable location services in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device plays back content without associating the content with location data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a display generation component and one or more input devices:
while presenting directional information corresponding to navigation directions from a first location to a second location, wherein the navigation directions are based on a determined route from the first location to the second location, detecting that the electronic device is no longer following the determined route; and
in response to detecting that the electronic device is no longer following the determined route:
in accordance with a determination that contextual data, other than a location of the electronic device relative to the determined route, does not satisfy one or more criteria, presenting the directional information directing a user of the electronic device back to the determined route from the first location to the second location; and
in accordance with a determination that the contextual data satisfies the one or more criteria, forgoing presenting the directional information directing the user of the electronic device back to the determined route.

2. The method of claim 1, wherein the contextual data includes information from a plurality of applications.

3. The method of claim 1, wherein a visual sensor, an inertial sensor, an odometry sensor, an inertial measurement unit, or any combination thereof, are included in one or more headphone devices worn by the user and determining a respective location of the electronic device relative to the determined route is based on data from the visual sensor, the inertial sensor, the odometry sensor, the inertial measurement unit, or any combination thereof.

4. The method of claim 3, wherein the odometry sensor is configured to be used to determine a change in position relative to a known respective position relative to the determined route.

5. The method of claim 3, wherein in accordance with a determination that a current location of the electronic device relative to the determined route is indoors, data from the visual sensor, the inertial sensor, the odometry sensor, the inertial measurement unit, or any combination thereof is used to determine the respective location of the electronic device along the determined route.

6. The method of claim 3, wherein:
in accordance with a determination that a current location of the electronic device relative to the determined route corresponds to a waypoint along the determined route, data from the visual sensor, the inertial sensor, the odometry sensor, the inertial measurement unit, or any combination thereof is used for determining the current location of the electronic device relative to the determined route, and
in accordance with a determination that the current location of the electronic device relative to the determined route does not correspond to a waypoint along the determined route, data from the visual sensor and the odometry sensor is not used for determining the current location of the electronic device relative to the determined route.

7. The method of claim 3, wherein one or more locations of one or more waypoints along the determined route are determined based on data from the visual sensor, the inertial sensor, the odometry sensor, the inertial measurement unit, or any combination thereof used to determine a current location of the electronic device relative to a starting location of the determined route.

8. The method of claim 3, wherein while navigating along the determined route:
in accordance with a determination that a current portion of the determined route includes a vertical change in position from a first altitude position to a second altitude position, forgoing using data from one or more of the visual sensor, the inertial sensor, the odometry sensor, or the inertial measurement unit to determine a current location of the electronic device relative to the determined route, and using data from an altimeter to determine the current location of the electronic device relative to the determined route, wherein data from the visual sensor, the inertial sensor, the odometry sensor, and/or the inertial measurement unit is used again to determine the current location of the electronic device relative to the determined route when the electronic device reaches the second altitude position.

9. The method of claim 1, further comprising:
in response to detecting that the electronic device is no longer following the determined route and in accordance with the determination that the contextual data satisfies the one or more criteria, presenting updated navigation information directing the user of the electronic device to an updated location not included in the determined route.

10. The method of claim 9, wherein the updated navigation information includes voice navigation instructions directing the user to the updated location.

11. The method of claim 9, wherein the electronic device uses pre-mapped data to direct the user to the updated location.

12. The method of claim 9, wherein data from a visual sensor, an inertial sensor, an odometry sensor, an altimeter, or any combination thereof, is used to direct the user to the updated location.

13. The method of claim 1, further comprising:
while navigating along the determined route, providing audio feedback that indicates a location of the electronic device relative to the determined route.

14. The method of claim 1, further comprising:
while presenting the directional information corresponding to the navigation directions from the first location to the second location;
in accordance with a determination that the electronic device is following the determined route, generating voice navigation instructions directing the user along the determined route; and
in accordance with a determination that the electronic device is no longer following the determined route, ceasing generating voice navigation instructions.

15. The method of claim 14, further comprising:
after detecting that the electronic device is no longer following the determined route and ceasing generating voice navigation instructions, detecting that the electronic device has returned to the determined route; and
in response to detecting that the electronic device has returned to the determined route, reactivating the voice navigation instructions directing the user along the determined route.

16. The method of claim 1, further comprising:
while navigating along the determined route, generating feedback that is based on determining that the electronic device is following the determined route wherein the feedback indicates that the electronic device is following the determined route.

17. The method of claim 16, further comprising:
in response to detecting that the electronic device is no longer following the determined route, ceasing the generation of the feedback.

18. The method of claim 1, wherein the contextual data includes data from a visual sensor, an inertial sensor, an odometry sensor, an inertial measurement unit, or any combination thereof, that is used for determining a respective direction to which the user is looking.

19. The method of claim 1, wherein the contextual data includes information related to an environment associated with the determined route, present weather conditions, a time of day, historical data associated with the user, information related to past behavior of the user, information related to current behavior of the user, or any combination thereof.

20. The method of claim 1, wherein the contextual data includes information related to one or more current behaviors of one or more people, other than the user of the electronic device, in an environment of the user.

21. An electronic device that is in communication with one or more input devices and a display generation component, the electronic device comprising:
one or more processors;
memory; and
one or more programs, wherein the one or more programs are stored in the memory and are configured to be executed by the one or more processors, the one or more programs including instructions for:
while presenting directional information corresponding to navigation directions from a first location to a second location, wherein the navigation directions are based on a determined route from the first location to the second location, detecting that the electronic device is no longer following the determined route; and
in response to detecting that the electronic device is no longer following the determined route:
in accordance with a determination that contextual data, other than a location of the electronic device relative to the determined route, does not satisfy one or more criteria, presenting the directional information directing a user of the electronic device back to the determined route from the first location to the second location; and
in accordance with a determination that the contextual data satisfies the one or more criteria, forgoing presenting the directional information directing the user of the electronic device back to the determined route.

22. A non-transitory computer readable storage medium storing one or more programs, the one or more programs comprising instructions, which when executed by one or more processors of an electronic device that is in communication with one or more input devices and a display generation component, cause the electronic device to perform a method comprising:
while presenting directional information corresponding to navigation directions from a first location to a second location, wherein the navigation directions are based on a determined route from the first location to the second location, detecting that the electronic device is no longer following the determined route; and
in response to detecting that the electronic device is no longer following the determined route:
in accordance with a determination that contextual data, other than a location of the electronic device relative to the determined route, does not satisfy one or more criteria, presenting the directional information directing a user of the electronic device back to the determined route from the first location to the second location; and
in accordance with a determination that the contextual data satisfies the one or more criteria, forgoing presenting the directional information directing the user of the electronic device back to the determined route.
